(19) United States
(12) Patent Application Publication
(10) Pub. No.: US 2025/0088932 A1
(43) Pub. Date: Mar. 13, 2025

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN); Jiangsheng FAN, Dongguan (CN)

(21) Appl. No.: 18/958,737

(22) Filed: Nov. 25, 2024

Related U.S. Application Data
(63) Continuation of application No. PCT/CN2022/094890, filed on May 25, 2022.

(51) Int. Cl. H04W 36/30; H04W 36/00

(52) U.S. Cl. CPC H04W 36/30; H04W 36/0085

(57) ABSTRACT

A wireless communication method is applied to a third network device, the third network device includes a DU, the wireless communication method includes: determining, by the DU according to a measurement result reported by a terminal device, to perform a cell handover based on a layer 1 or layer 2 signaling, and determining a target cell.

### CROSS-REFERENCE TO RELATED APPLICATION

This application is a Continuation Application of International Application No. PCT/CN2022/094890 filed on May 25, 2022, which is incorporated herein by reference in its entirety.

### TECHNICAL FIELD

Embodiments of the present disclosure relate to the field of communications, and in particular, to a wireless communication method and a device.

### RELATED ART

In order to strengthen the information interaction between various stations to realize coordinated communication, a 5G base station has introduced a CU-DU separation architecture, where the segmentation of centralized unit (CU) and distributed unit (DU) is carried out according to real-time requirements of different protocol layers. The CU-DU separation architecture is conducive to realizing baseband resource sharing, slicing and cloudification of wireless access, and satisfying the problem of station coordination in a complex 5G networking situation. However, in the CU-DU separation architecture, how to realize a cell handover is a problem that needs to be solved.

### SUMMARY

In a first aspect, there is provided a wireless communication method, the method is applied to a third network device, the third network device includes a source DU, the method includes:
determining, by the source DU, according to a measurement result reported by a terminal device, to perform a cell handover based on a layer 1 or layer 2 signaling, and determining a target cell.

In a second aspect, there is provided a wireless communication method, the method is applied to a fourth network device, the fourth network device includes a CU, the method includes:
receiving, by the CU, first request information transmitted from a source DU;
where the first request information is used for requesting to perform a cell handover based on a layer 1 or layer 2 signaling, and the first request information includes an identity of a target cell determined by the source DU.

In a third aspect, there is provided a network device, including a processor and a memory; the memory is configured to store a computer program, and the processor is configured to call and run the computer program stored in the memory, so as to enable the network device to perform:
determining according to a measurement result reported by a terminal device, to perform a cell handover based on a layer 1 or layer 2 signaling, and determining a target cell; where the network device includes a source DU.

### BRIEF DESCRIPTION OF THE DRAWINGS

FIG. 1 is a schematic diagram of a communication system architecture applied in the embodiments of the present disclosure.

FIG. 2 is a schematic diagram of an inter-base station cell handover provided by the present disclosure.

FIG. 3 is a schematic diagram of a protocol layer segmentation of a CU, a DU and an AAU provided by the present disclosure.

FIG. 4 is a schematic diagram of a CU-DU separation architecture provided by the present disclosure.

FIG. 5 is a schematic diagram of a cell handover within an intra-CU-inter-DU range provided by the present disclosure.

FIG. 6 is a schematic flowchart of a wireless communication method, provided according to the embodiments of the present disclosure.

FIG. 7 is a schematic flowchart of another wireless communication method, provided according to the embodiments of the present disclosure.

FIG. 8 is a schematic flowchart of a cell handover, provided according to the embodiments of the present disclosure.

FIG. 9 is a schematic flowchart of yet another wireless communication method, provided according to the embodiments of the present disclosure.

FIG. 10 is a schematic flowchart of yet another wireless communication method, provided according to the embodiments of the present disclosure.

FIG. 11 is a schematic flowchart of another cell handover, provided according to the embodiments of the present disclosure.

FIG. 12 is a schematic block diagram of a network device, provided according to the embodiments of the present disclosure.

FIG. 13 is a schematic block diagram of another network device, provided according to the embodiments of the present disclosure.

FIG. 14 is a schematic block diagram of yet another network device, provided according to the embodiments of the present disclosure.

FIG. 15 is a schematic block diagram of yet another network device, provided according to the embodiments of the present disclosure.

FIG. 16 is a schematic block diagram of a communication device, provided according to the embodiments of the present disclosure.

FIG. 17 is a schematic block diagram of an apparatus, provided according to the embodiments of the present disclosure.

FIG. 18 is a schematic block diagram of a communication system, provided according to the embodiments of the present disclosure.

### DETAILED DESCRIPTION

Technical solutions in the embodiments of the present disclosure will be described below, in conjunction with the drawings of the embodiments of the present disclosure. Obviously, the described embodiments are merely some but not all of the embodiments of the present disclosure. All other embodiments obtained based on the embodiments of the present disclosure by those ordinary skilled in the art shall be included in the protection scope of the present disclosure.

The technical solutions in the embodiments of the present disclosure may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial Networks (NTN) system, a universal mobile telecommunication system (UMTS), a wireless local area networks (WLAN), a internet of things (IoT), a wireless fidelity (WiFi), a fifth-generation (5G) communication system or other communication systems.

Generally speaking, traditional communication systems support a limited number of connections, which are also easy to implement. However, with the development of communication technology, mobile communication systems will not only support traditional communications, but will also support, for example, device to device (D2D) communication, machine to machine (M2M) communication, machine type communication (MTC), vehicle to vehicle (V2V) communication, sidelink (SL) communication, vehicle to everything (V2X) communication. The embodiments of the present disclosure may also be applied to these communication systems.

In some embodiments, the communication system in the embodiments of the present disclosure may be applied to a CU-DU separation scenario, a carrier aggregation (CA) scenario, a dual connectivity (DC) scenario, a standalone (SA) networking scenario, or a non-standalone (NSA) networking scenario.

In some embodiments, the communication system in the embodiments of the present disclosure may be applied to an unlicensed spectrum, where the unlicensed spectrum may also be considered as a shared spectrum; or the communication system in the embodiments of the present disclosure may also be applied to an licensed spectrum, where the licensed spectrum may also be considered as an unshared spectrum.

In some embodiments, the communication system in the embodiments of the present disclosure may be applied to an FR1 frequency band (corresponding to a frequency band range of 410 MHz to 7.125 GHZ), and may also be applied to an FR2 frequency band (corresponding to a frequency band range of 24.25 GHz to 52.6 GHZ), and may also be applied to a new frequency band such as a high-frequency frequency band corresponding to a frequency band range of 52.6 GHz to 71 GHz or corresponding to a frequency band range of 71 GHz to 114.25 GHz.

The embodiments of the present disclosure describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user device, or the like.

The terminal device may be a station (ST) in the WLAN, which may be a cellular phone, a cordless phone, a session initiation protocol (SIP) phone, a wireless local loop (WLL) station, a personal digital assistant (PDA) device, a handheld device and a computing device with a wireless communication function, or other processing devices connected to a wireless modem, a vehicle-mounted device, a wearable device, a terminal device in a next-generation communication system (such as in an NR network), a terminal device in a future evolved public land mobile network (PLMN) network, or the like.

In the embodiments of the present disclosure, the terminal device may be deployed on land, including indoor or outdoor, in handheld, worn or vehicle-mounted, which may also be deployed on water (e.g., on a ship), and may also be deployed in the air (e.g., on an airplane, a balloon, and a satellite).

In the embodiments of the present disclosure, the terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, an in-vehicle communication device, a wireless communication chip/application specific integrated circuit (ASIC)/system on chip (SoC), or the like.

As an example but not a limitation, in the embodiments of the present disclosure, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes. The wearable device is a portable device that is worn directly on the body, or integrated into the user's clothing or accessories. The wearable device is not just a hardware device, but also implements powerful functions through software supporting, data interaction, and cloud interaction. In a broad sense, wearable smart devices include those that are fully functional, large in size, and may implement complete or partial functions without relying on smartphones, such as smart watches or smart glasses, as well as those that only focus on a certain type of application function and need to be used in conjunction with other devices (such as smartphones), such as various smart bracelets and smart jewelry for physical sign monitoring.

In the embodiments of the present disclosure, the network device may be a device used for communicating with a mobile device. The network device may be an access point (AP) in the WLAN, a base station (Base Transceiver Station, BTS) in the GSM or CDMA. The network device may also be a base station (NodeB, NB) in the WCDMA, and may further be an evolutional base station (evolutional Node B, eNB or eNodeB) in the LTE, a relay station or an access point, a vehicle-mounted device, a wearable device, a network device or a base station (gNB) in an NR network, a next generation Evolutional NodeB (NG-eNB), a network device in the future evolved PLMN network, a network device in the NTN network, or the like.

As an example but not a limitation, in the embodiments of the present disclosure, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may also be a base station provided on land, water, and other places.

In the embodiments of the present disclosure, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station, or may also belong to a base station corresponding to a small cell, and the small cell herein may include: a metro cell, a micro cell, a pico cell, a femto cell, etc., these small cells have characteristics of small coverage range and low transmission power, which are applicable for providing a data transmission service with high speed.

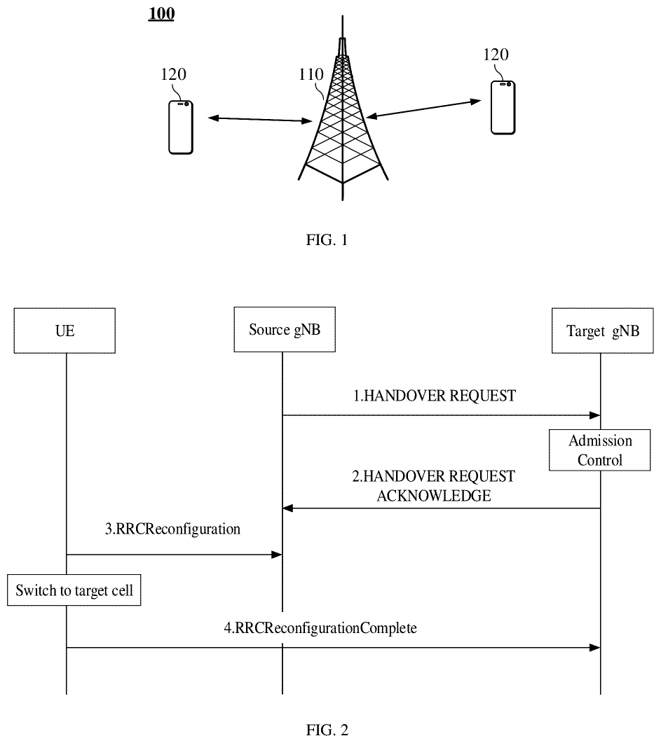

Exemplarily, a communication system 110 applied in the embodiments of the present disclosure is shown in FIG. 1. The communication system 100 may include a network device 110, which may be a device for communicating with a terminal device 120 (or referred to as a communication terminal or a terminal). The network device 110 may provide communication coverage for a specific geographical area and may communicate with a terminal device located within the coverage area.

FIG. 1 exemplarily shows one network device and two terminal devices. In some embodiments, the communication system may include multiple network devices, and there may be another number of terminal devices within a coverage range of each network device, which is not limited in the embodiments of the present disclosure.

In some embodiments, the communication system 100 may further include other network entities such as a network controller and a mobility management entity, which is not limited in the embodiments of the present disclosure.

It should be understood that, in the embodiments of the present disclosure, a device with a communication function in the network/system may be referred to as a communication device. Taking the communication system 100 shown in FIG. 1 as an example, the communication device may include the network device 110 and the terminal device 120 with communication functions, and the network device 110 and the terminal device 120 may be devices described above, which will not be repeated herein; the communication device may further include other devices in the communication system 110, such as other network entities (e.g., a network controller, a mobility management entity), which are not limited in the embodiments of the present disclosure.

It should be understood that the terms “system” and “network” are often used interchangeably herein. Herein, the term “and/or” is only an association relationship to describe associated objects, which means that there may be three kinds of relationships. For example, A and/or B may represent three cases that: A exists alone, both A and B exist, and B exists alone. In addition, a character “/” herein generally means that related objects before and after “/” are in an “or” relationship.

It should be understood that a first communication device and a second communication device are involved herein, where the first communication device may be a terminal device, such as a mobile phone, a machine facility, a customer premise equipment (CPE), an industrial equipment, a vehicle; the second communication device may be a counterpart communication device of the first communication device, such as a network device, a mobile phone, an industrial equipment, a vehicle.

The terms used in the implementation section of the present disclosure are only used to explain embodiments of the present disclosure, and are not intended to limit the present disclosure. The terms “first”, “second”, “third” and “fourth” and the like in the specification, claims and drawings of the present disclosure are used to distinguish different objects rather than to describe a specific order. In addition, the terms “include” and “have” and any variations thereof, are intended to cover a non-exclusive inclusion.

It should be understood that “indicate” and any variations thereof mentioned in the embodiments of the present disclosure may mean a direct indication, may mean an indirect indication, or may represent that there is an association relationship. For example, A indicates B, which may mean that A directly indicates B, for example, B may be acquired by A; or may mean that A indirectly indicates B, for example, A indicates C, and B may be acquired by C; or may mean that there is an association relationship between A and B.

In the description of the embodiments of the present disclosure, the term “correspond” and any variations thereof may mean that there is a direct correspondence or indirect correspondence between two, or may mean that there is an associated relationship between the two, or may mean a relationship of indicating and being indicated or a relationship of configuring and being configured, etc.

In the embodiments of the present disclosure, “predefinition” or “preconfiguration” and any variations thereof may be implemented by pre-saving corresponding codes, tables or other manners that may be used for indicating related information, in a device (e.g., including a terminal device and a network device), the present disclosure does not limit its implementation. For example, predefinition may refer to what is defined in a protocol.

In the embodiments of the present disclosure, the “protocol” may refer to a standard protocol in the field of communication, for example, which may be an evolution of existing LTE protocol, NR protocol, Wi-Fi protocol, or other protocols related to communication systems related thereto, and the present disclosure does not limit the types of protocols.

In order to facilitate understanding of the technical solutions of the embodiments of the present disclosure, the technical solutions of the present disclosure are described in detail below through some embodiments. The following related technologies may be arbitrarily combined with the technical solutions of the embodiments of the present disclosure as optional solutions, which all fall within the protection scope of the embodiments of the present disclosure. The embodiments of the present disclosure include at least part of the following contents.

The term “centralized unit (CU)” used in the present disclosure refers to a logical node that can be implemented on any suitable device, including gNB functions, such as user data transmission, mobility control, radio access network sharing, positioning, session management, except for a function allocated to DU, e.g., gNB-CU host RRC, service data adaptation protocol (SDAP) and packet data convergence protocol (PDCP) of gNBs or RRC and PDCP protocols of en-gNB, used to control the operation of one or more gNB-DUs. A CU controls the operation of DUs on front-haul F1 interface. Centralized unit (CU) may also be called the baseband unit (BBU)/radio cloud center (RCC)/centralized radio access network (C-RAN)/virtualized radio access network (V-RAN).

The term “distributed unit (DU)” as used in the present disclosure refers to a logical node that may be implemented on any suitable device, and includes a subset of gNB functionality, which depends on the functional segmentation options. For example, a gNB-DU hosts RLC, MAC, and physical (PHY) layers of a gNB or en-gNB, and operations of the the gNB-DU are partially controlled by a gNB-CU. One DU supports one or more cells. One DU is only connected to one CU. One cell is supported by only one gNB-DU. gNB-DU terminates F1 interface connected to the CU, and operations of gNB-DU is controlled by CU. A distributed unit (DU) may also be referred to by other names, such as a remote radio head (RRH)/remote radio unit (RRU).

In order to facilitate a proper understanding of the embodiments of the present disclosure, the conventional handover process related to the present disclosure are described.

Similar to LTE system, an NR system supports the handover process of UEs in a connected state. In a case where a user who is using network services moves from one cell to another, or due to reasons such as wireless transmission service load adjustment, activation operation maintenance, equipment failure, in order to ensure communication continuity and service quality, the system has to transfer a communication link between the user and the original cell to the new cell, that is, perform a handover process.

FIG. 2 is a schematic diagram of an inter-base station cell handover, and the general process is described as follows:
1. A source gNB triggers a handover based on a layer 3 (L3) measurement result reported by a terminal and transmits a handover request to a target cell through an Xn interface;
2. A target gNB receives the handover request from the source gNB, provides the radio resource control (RRC) configuration of the target cell, and feeds back the RRC configuration to the source gNB as part of handover request acknowledge;
3. The source gNB transmits an RRC reconfiguration message (RRCReconfiguration) to a terminal device (UE) to indicate that the terminal device initiates a handover process, as well as RRC configuration information for accessing the target cell;
4. The UE accesses the target cell and transmits an RRC reconfiguration complete message (RRCReconfigurationComplete) to the target cell.

In order to facilitate a proper understanding of the embodiments of the present disclosure, mobility management in the CU-DU separation architecture related to the present disclosure is described.

The main equipment of the base station is mainly composed of a base band unit (BBU) and an active antenna unit (AAU). The main function of BBU is to process baseband signals. The main function of AAU is to convert a baseband digital signal into an analog signal, which is then modulated into a high-frequency RF signal. Power is amplified by power amplifier unit, and finally, the high-frequency RF signal is transmitted through an antenna.

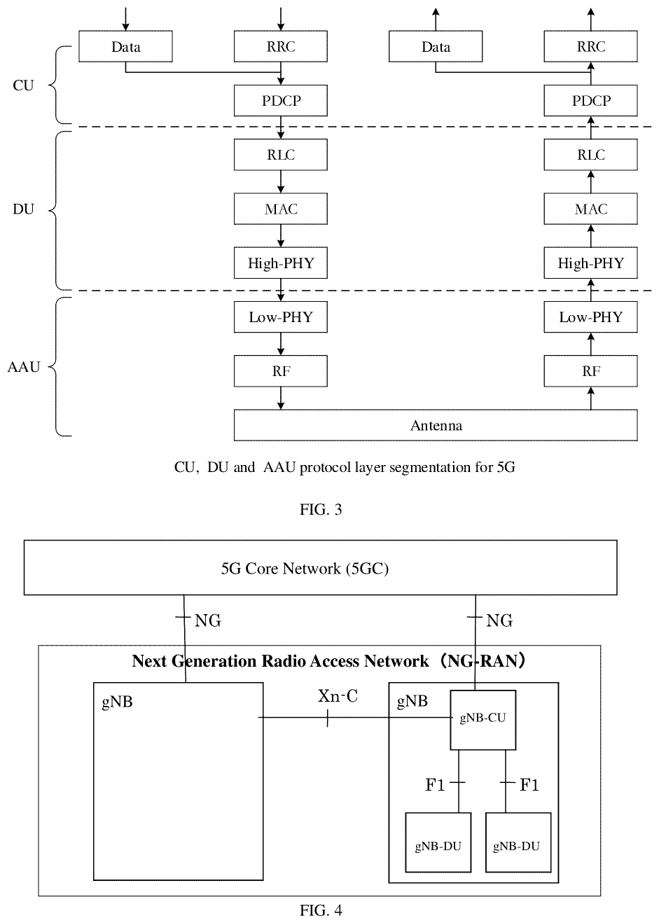

In order to strengthen information interaction between stations to realize coordinated communication, a 5G base station has introduced a CU-DU separation architecture. The segmentation of CU and DU is carried out according to the real-time requirements of different protocol layers. Under this principle, low physical layer (Low-PHY) in an original BBU is moved down to an AAU for processing, and high physical layer (High-PHY), media access control (MAC) layer, and radio link control (RLC) layer that require high real-time performance are processed in DU, while packet data convergence protocol (PDCP) and RRC layer that does not require high real-time performance are processed in CU, as shown in FIG. 3. The CU-DU separation architecture is conducive to realizing baseband resource sharing, slicing and cloudification of wireless access, and satisfying the problem of site coordination in a complex 5G networking situation.

In some embodiments, a gNB-CU can be connected to one or more gNB-DUs, but a gNB-DU can only be connected to one gNB-CU. The gNB-CU and gNB-DU exchange data/signaling through an F1 interface, as shown in FIG. 4.

In the CU-DU architecture, mobility management is divided into the following two categories.

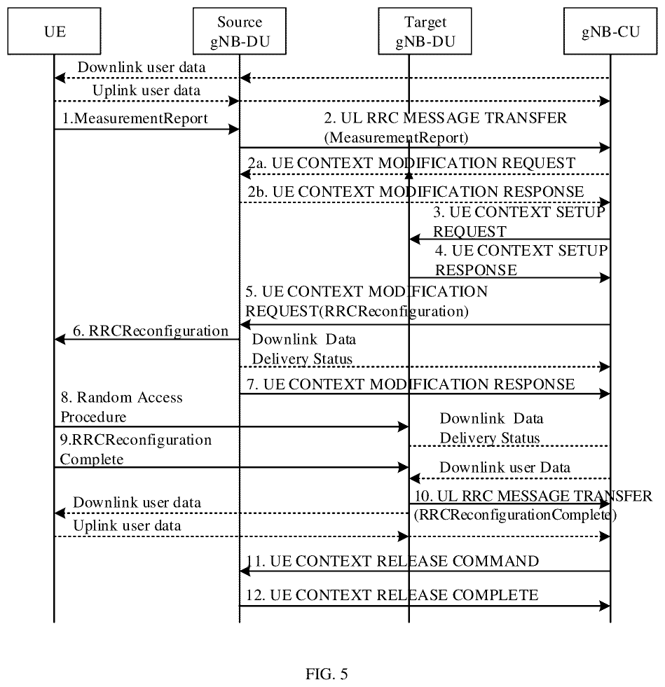

A cell handover within the range of intra-CU-inter-DU (a process in the network side is shown in FIG. 5). For example, a UE reports a L3 measurement result to a network, and the L3 measurement result are processed by a source DU and delivered to a CU; the CU performs handover decision and determines a target cell (the target cell and the current cell belong to different DUs); the CU migrates the underlying uplink text of the UE from the source DU to a target DU; generates a handover instruction (RRCReconfiguration) and transmits the handover instruction to the UE via the source DU; A cell handover within the range of intra-CU-intra-DU; a UE reports the L3 measurement result to a network, and the L3 measurement result are processed by a source DU and delivered to a CU; the CU performs the handover decision and determines a target cell (the target cell and the current cell belong to the same DU); the CU performs the UE context modification process (2a&2b in FIG. 5) to update the underlying context of the UE in the DU; generates a handover instruction (RRCReconfiguration) and transmits the handover instruction to the UE via the source DU.

In order to facilitate a proper understanding of the embodiments of the present disclosure, problems solved by the present disclosure are explained.

In order to reduce the latency caused by a L3 handover (i.e., a cell handover based on a layer 3 signaling), a layer 1 (L1)/layer 2 (L2) handover (i.e., a cell handover based on a layer 1 or layer 2 signaling) is introduced. The L1/L2 handover process can reduce the protocol stack processing latency at the following two levels.
the L1/L2 handover is based on a measurement result reported by a UE through a L1/L2 signaling, such as channel state information (CSI) measurement reporting, or cell measurement results filtered by L1;
triggering of L1/L2 handover is done by a network issuing a L1/L2 signaling, such as media access control control element (MAC CE) and/or downlink control information (DCI).

L1/L2 mobility model (i.e., serving cell change):
1. A UE receives a synchronization signal block (SSB) configuration of cells with different physical cell identities (PCI) from the serving cell for beam measurement/serving cell change;
2. The UE performs beam measurements on cells with different PCIs and reports them to the serving cell;
3. Providing the UE with a serving cell configuration for cells with other PCIs through an RRC signaling;
4. Transmission configuration indicator (TCI) state of cells with different PCIs is activated as the serving cell changes (through an L1/L2 signaling);
5. The UE changes the serving cell and starts receiving/transmitting by using a pre-configured UE dedicated channel and TCI state.

A basic process for L1/L2 mobility:

1. A UE receives candidate cell configuration information from a current serving cell, each candidate cell is associated with an SSB configuration. After receiving the configuration, the UE performs a measurement on the SSB of the candidate cell.

2. The UE reports the measurement results for the candidate cell SSBs to the current serving cell;

3. Based on the reported measurement results, the UE switches to one of the candidate cells, where the configuration information of the candidate cell is transmitted to the UE in advance through RRC. In a case where the UE switches to a target cell, the network can also indicate/activate TCI state information to provide the UE with beam information working in the target cell.

It can be seen that in the CU-DU separation architecture, the main process related to the L1/L2 handover mainly involves a protocol stack on the DU side, which is different from the L3 handover. Therefore, issues that need to be clarified include: how to make L1/L2 handover decisions, and what information needs to be interacted between CU-DU for the L1/L2 handover.

Based on the above problems, the present disclosure proposes an L1/L2 handover solution, where a CU implements a cell handover decision based on a layer 1 or layer 2 signaling, or a source DU implements a cell handover decision based on the layer 1 or layer 2 signaling, thereby realizing a cell handover based on the layer 1 or layer 2 signaling in a CU-DU separation architecture.

In the embodiments, a wireless communication method is provided, where the method is applied to a first network device, the first network device includes a centralized unit (CU), the method includes:
determining, by the CU, according to first measurement report information acquired from a source distributed unit (DU), to perform a cell handover based on a layer 1 or layer 2 signaling, and determining a target cell;
where the first measurement report information includes a measurement result reported by a terminal device.

In some embodiments, where the first measurement report information includes at least one of: all measurement results reported by the terminal device within a past time period T₁, a latest measurement result reported by the terminal device within the past time period T₁, or latest N₁ measurement results reported by the terminal device within the past time period T₁: where T₁ is a positive number and N₁ is a positive integer.

In some embodiments, where the source DU reports the first measurement report information to the CU once every time period T₁.

In some embodiments, where the time period T₁ is configured by the CU, or the time period T₁ is configured by the source DU; and/or, the N₁ is configured by the CU, or the N₁ is configured by the source DU.

In some embodiments, where the first measurement report information includes at least one of: all measurement results reported by the terminal device within a past time period T₂, a latest measurement result reported by the terminal device, or latest N₂ measurement results reported by the terminal device; where T₂ is a positive number and N₂ is a positive integer.

In some embodiments, where the first measurement report information is transmitted from the source DU based on a first F1 interface message transmitted from the CU; where the first F1 interface message includes first indication information and/or second indication information, the first indication information is used for indicating the source DU to report the measurement result reported by the terminal device, and the second indication information is used for indicating the source DU to report a measurement result of a first measurement object.

In some embodiments, where a type of the first measurement object includes one of: a frequency information list, a frequency and physical cell identity (PCI) combination information list, or a PCI information list.

In some embodiments, where the first measurement report information further includes measurement results of one or more cells corresponding to the first measurement object.

In some embodiments, where the time period T₂ is configured by the CU, or the time period T₂ is configured by the source DU; and/or, the N₂ is configured by the CU, or the N₂ is configured by the source DU.

In some embodiments, where the first measurement report information includes a measurement result currently reported by the terminal device.

In some embodiments, where the measurement result included in the first measurement report information is a measurement result of at least one cell; where the at least one cell is configured by the CU.

In some embodiments, where the first measurement report information is carried in an F1 application protocol (F1AP) message.

In some embodiments, where the cell handover based on the layer 1 or layer 2 signaling is an intra-DU handover, or the cell handover based on the layer 1 or layer 2 signaling is an inter-DU handover.

In some embodiments, where the method further includes:
transmitting, by the CU, first handover indication information to the source DU, where the first handover indication information is used for indicating the source DU to perform the cell handover based on the layer 1 or layer 2 signaling, and the first handover indication information at least includes an identity of the target cell.

In some embodiments, where the first handover indication information is carried in a terminal context modification request message, or the first handover indication information is carried in an F1AP message.

In some embodiments, where the method further includes:
receiving, by the CU, feedback information corresponding to the first handover indication information transmitted from the source DU.

In some embodiments, where the feedback information corresponding to the first handover indication information is carried in a terminal context modification response message, or the feedback information corresponding to the first handover indication information is carried in the F1AP message.

In some embodiments, where the measurement result is reported by the terminal device to the source DU through uplink control information (UCI) and/or a media access control control element (MAC CE).

In some embodiments, where the measurement result is a result obtained by the terminal device measuring a target object; where the target object is at least one of: a current serving cell, a candidate cell, a synchronization signal block (SSB) of a neighbor cell, or a channel state information-reference signal (CSI-RS).

In some embodiments, where the measurement result is cell quality and/or beam quality of the target object; where the cell quality or beam quality is characterized by one or more of following indicators: reference signal received power (RSRP), reference signal received quality (RSRQ), or signal to interference plus noise ratio (SINR).

In the embodiments, a wireless communication method is provided, where the method is applied to a second network device, the second network device includes a source distributed unit (DU), the method includes:
transmitting, by the source DU, first measurement report information to a centralized unit (CU);
where the first measurement report information includes a measurement result reported by a terminal device, and the first measurement report information is used for the CU to determine whether to perform a cell handover based on a layer 1 or layer 2 signaling.

In some embodiments, where the first measurement report information includes at least one of: all measurement results reported by the terminal device within a past time period T₁, a latest measurement result reported by the terminal device within the past time period T₁, or latest N₁ measurement results reported by the terminal device within the past time period T₁: where T₁ is a positive number and N₁ is a positive integer.

In some embodiments, where the source DU reports the first measurement report information to the CU once every time period T₁.

In some embodiments, where the time period T₁ is configured by the CU, or the time period T₁ is configured by the source DU; and/or, the N₁ is configured by the CU, or the N₁ is configured by the source DU.

In some embodiments, where the first measurement report information includes at least one of: all measurement results reported by the terminal device within a past time period T₂, a latest measurement result reported by the terminal device, or latest N₂ measurement results reported by the terminal device; where T₂ is a positive number and N₂ is a positive integer.

In some embodiments, where the first measurement report information is transmitted from the source DU based on a first F1 interface message transmitted from the CU; where the first F1 interface message includes first indication information and/or second indication information, the first indication information is used for indicating the source DU to report the measurement result reported by the terminal device, and the second indication information is used for indicating the source DU to report a measurement result of a first measurement object.

In some embodiments, where a type of the first measurement object includes one of: a frequency information list, a frequency and physical cell identity (PCI) combination information list, or a PCI information list.

In some embodiments, where the first measurement report information further includes measurement results of one or more cells corresponding to the first measurement object.

In some embodiments, where the time period T₂ is configured by the CU, or the time period T₂ is configured by the source DU; and/or, the N₂ is configured by the CU, or the N₂ is configured by the source DU.

In some embodiments, where the first measurement report information includes a measurement result currently reported by the terminal device.

In some embodiments, where the measurement result included in the first measurement report information is a measurement result of at least one cell; where the at least one cell is configured by the CU.

In some embodiments, where the first measurement report information is carried in an F1 application protocol (F1AP) message.

In some embodiments, where the cell handover based on the layer 1 or layer 2 signaling is an intra-DU handover, or the cell handover based on the layer 1 or layer 2 signaling is an inter-DU handover.

In some embodiments, where the method further includes:
receiving, by the source DU, first handover indication information transmitted from the CU, where the first handover indication information is used for indicating the source DU to perform the cell handover based on the layer 1 or layer 2 signaling, and the first handover indication information at least includes an identity of a target cell determined by the CU.

In some embodiments, where the first handover indication information is carried in a terminal context modification request message, or the first handover indication information is carried in an F1AP message.

In some embodiments, where the method further includes:
transmitting, by the source DU, second handover indication information to the terminal device, where the second handover indication information is used for indicating the terminal device to switch to the target cell.

In some embodiments, where the second handover indication information is carried in the layer 1 or layer 2 signaling.

In some embodiments, where the layer 1 or layer 2 signaling is a media access control control element (MAC CE) or downlink control information (DCI).

In some embodiments, where before transmitting the second handover indication information, the method further includes:
transmitting, by the source DU to the CU, feedback information corresponding to the first handover indication information.

In some embodiments, where the feedback information corresponding to the first handover indication information is carried in a terminal context modification response message, or the feedback information corresponding to the first handover indication information is carried in an F1AP message.

In some embodiments, where the measurement result is reported by the terminal device to the source DU through uplink control information (UCI) and/or a media access control control element (MAC CE).

In some embodiments, where the measurement result is a result obtained by the terminal device measuring a target object; where the target object is at least one of: a current serving cell, a candidate cell, a synchronization signal block (SSB) of a neighbor cell, or a channel state information-reference signal (CSI-RS).

In some embodiments, where the measurement result is cell quality and/or beam quality of the target object; where the cell quality or beam quality is characterized by one or more of following indicators: reference signal received power (RSRP), reference signal received quality (RSRQ), or signal to interference plus noise ratio (SINR).

In the embodiments, a wireless communication method is provided, where the method is applied to a third network device, the third network device includes a source distributed unit (DU), the method includes:
determining, by the source DU according to a measurement result reported by a terminal device, to perform a cell handover based on a layer 1 or layer 2 signaling, and determining a target cell.

In some embodiments, where the method further includes:
transmitting, by the source DU, first request information to a centralized unit (CU);
where the first request information is used for requesting to perform the cell handover based on the layer 1 or layer 2 signaling, and the first request information includes an identity of the target cell.

In some embodiments, where the first request information is carried in an F1 application protocol (F1AP) message.

In some embodiments, where the method further includes:
receiving, by the source DU, first feedback information transmitted from the CU;
where the first feedback information is determined based on the first request information, and the first feedback information is used for indicating whether the source DU performs the cell handover based on the layer 1 or layer 2 signaling.

In some embodiments, where the first feedback information is carried in an F1AP message.

In some embodiments, where the method further includes:
in a case where the first feedback information indicates that the source DU performs the cell handover based on the layer 1 or layer 2 signaling, transmitting, by the source DU, a handover indication information to the terminal device, where the handover indication information is used for indicating the terminal device to switch to the target cell.

In some embodiments, where the handover indication information is carried in the layer 1 or layer 2 signaling.

In some embodiments, where the layer 1 or layer 2 signaling is a media access control control element (MAC CE) or downlink control information (DCI).

In some embodiments, where the first request information further includes at least one of: second measurement report information, or latest configuration information of the terminal device; where the second measurement report information includes a measurement result reported by the terminal device, and the second measurement report information is used for the CU to determine whether to indicate the source DU to perform the cell handover based on the layer 1 or layer 2 signaling.

In some embodiments, where the measurement result in the second measurement report information includes at least one of: a cell level layer 1 measurement result of a serving cell, and/or, a beam level layer 1 measurement result of the serving cell; a cell level layer 1 measurement result of at least one neighbor cell, and/or, a beam level layer 1 measurement result of at least one neighbor cell; or a cell level layer 1 measurement result of the target cell, and/or a beam level layer 1 measurement result of the target cell.

In some embodiments, where the second measurement report information includes at least one of: all measurement results reported by the terminal device within a past time period T, a latest measurement result reported by the terminal device within the past time period T, latest N measurement results reported by the terminal device within the past time period T; a latest measurement result reported by the terminal device, latest N measurement results reported by the terminal device; or a measurement result currently reported by the terminal device; where T is a positive number and N is a positive integer.

In some embodiments, where the time period T is configured by the CU, or the time period T is configured by the source DU; and/or, the N is configured by the CU, or the N is configured by the source DU.

In some embodiments, where the second measurement report information is transmitted from the source DU based on a first F1 interface message transmitted from the CU; where the first F1 interface message includes first indication information and second indication information, where the first indication information is used for indicating the source DU to report the measurement result reported by the terminal device, and the second indication information is used for indicating the source DU to report a measurement result of a first measurement object.

In some embodiments, where a type of the second measurement object includes one of: a frequency information list, a frequency and physical cell identity (PCI) combination information list, or a PCI information list.

In some embodiments, where the measurement result included in the second measurement report information is a measurement result of at least one cell; where the at least one cell is configured by the CU.

In some embodiments, where the method further includes:
receiving, by the source DU, a terminal context modification request transmitted from the CU, and the terminal context modification request is used for requesting latest terminal configuration information; and
transmitting, by the source DU, a terminal context modification response to the CU, and the terminal context modification response includes latest configuration information of the terminal device.

In some embodiments, where the cell handover based on the layer 1 or layer 2 signaling is an intra-DU handover, or the cell handover based on the layer 1 or layer 2 signaling is an inter-DU handover.

In some embodiments, where the measurement result is reported by the terminal device to the source DU through uplink control information (UCI) and/or a media access control control element (MAC CE).

In some embodiments, where the measurement result is a result obtained by the terminal device measuring a target object; where the target object is at least one of: a current serving cell, a candidate cell, a synchronization signal block (SSB) of a neighbor cell, or a channel state information-reference signal (CSI-RS).

In some embodiments, where the measurement result is cell quality and/or beam quality of the target object; where the cell quality or beam quality is characterized by one or more of following indicators: reference signal received power (RSRP), reference signal received quality (RSRQ), or signal to interference plus noise ratio (SINR).

In the embodiments, a wireless communication method is provided, where the method is applied to a fourth network device, the fourth network device includes a centralized unit (CU), the method includes:
receiving, by the CU, first request information transmitted from a source distributed unit (DU);
where the first request information is used for requesting to perform a cell handover based on a layer 1 or layer 2 signaling, and the first request information includes an identity of a target cell determined by the source DU.

In some embodiments, where the first request information is carried in an F1 application protocol (F1AP) message.

In some embodiments, where the method further includes:
transmitting, by the CU, first feedback information to the source DU;
where the first feedback information is determined based on the first request information, and the first feedback information is used for indicating whether the source DU performs the cell handover based on the layer 1 or layer 2 signaling.

In some embodiments, where the first feedback information is carried in an F1AP message.

In some embodiments, where the first request information further includes at least one of: second measurement report information, or latest configuration information of the terminal device; where the second measurement report information includes a measurement result reported by the terminal device, and the second measurement report information is used for the CU to determine whether to indicate the source DU to perform the cell handover based on the layer 1 or layer 2 signaling.

In some embodiments, where the measurement result in the second measurement report information includes at least one of: a cell level layer 1 measurement result of a serving cell, and/or, a beam level layer 1 measurement result of the serving cell; a cell level layer 1 measurement result of at least one neighbor cell, and/or, a beam level layer 1 measurement result of at least one neighbor cell; or a cell level layer 1 measurement result of the target cell, and/or a beam level layer 1 measurement result of the target cell.

In some embodiments, where the second measurement report information includes at least one of: all measurement results reported by the terminal device within a past time period T, a latest measurement result reported by the terminal device within the past time period T, latest N measurement results reported by the terminal device within the past time period T; a latest measurement result reported by the terminal device, latest N measurement results reported by the terminal device; or a measurement result currently reported by the terminal device; where T is a positive number and N is a positive integer.

In some embodiments, where the time period T is configured by the CU, or the time period T is configured by the source DU; and/or, the N is configured by the CU, or the N is configured by the source DU.

In some embodiments, where the second measurement report information is transmitted from the source DU based on a first F1 interface message transmitted from the CU; where the first F1 interface message includes first indication information and second indication information, where the first indication information is used for indicating the source DU to report the measurement result reported by the terminal device, and the second indication information is used for indicating the source DU to report a measurement result of a first measurement object.

In some embodiments, where a type of the second measurement object includes one of: a frequency information list, a frequency and physical cell identity (PCI) combination information list, or a PCI information list.

In some embodiments, where the measurement result included in the second measurement report information is a measurement result of at least one cell; where the at least one cell is configured by the CU.

In some embodiments, where the method further includes:
transmitting, by the CU, a terminal context modification request to the source DU, and the terminal context modification request is used for requesting latest terminal configuration information; and
receiving, by the CU, a terminal context modification response transmitted from the source DU, and the terminal context modification response includes latest configuration information of the terminal device.

In some embodiments, where the cell handover based on the layer 1 or layer 2 signaling is an intra-DU handover, or the cell handover based on the layer 1 or layer 2 signaling is an inter-DU handover.

In some embodiments, where the measurement result is reported by the terminal device to the source DU through uplink control information (UCI) and/or a media access control control element (MAC CE).

In some embodiments, where the measurement result is a result obtained by the terminal device measuring a target object; where the target object is at least one of: a current serving cell, a candidate cell, a synchronization signal block (SSB) of a neighbor cell, or a channel state information-reference signal (CSI-RS).

In some embodiments, where the measurement result is cell quality and/or beam quality of the target object; where the cell quality or beam quality is characterized by one or more of following indicators: reference signal received power (RSRP), reference signal received quality (RSRQ), or signal to interference plus noise ratio (SINR).

The technical solution of the present disclosure will be described in detail below through some embodiments.

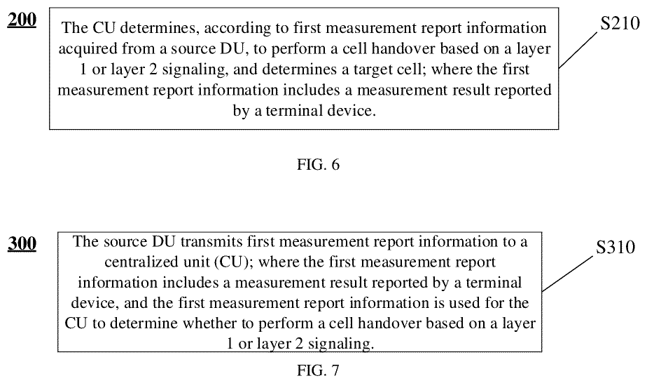

FIG. 6 is a schematic flowchart of a wireless communication method 200 according to the embodiments of the present disclosure. The wireless communication method 200 is applied to a first network device, and the first network device includes a CU. As shown in FIG. 6, the wireless communication method 200 may include at least part of the following contents.

In S210, the CU determines, according to first measurement report information acquired from a source DU, to perform a cell handover based on a layer 1 or layer 2 signaling, and determines a target cell; where the first measurement report information includes a measurement result reported by a terminal device.

In the embodiments of the present disclosure, the CU implements a cell handover decision based on the layer 1 or layer 2 signaling, thereby realizing the cell handover based on the layer 1 or layer 2 signaling in a CU-DU separation architecture.

It should be understood that “the cell handover based on the layer 1 or layer 2 signaling” may also be referred to as “L1/L2 handover”, which is not limited in the present disclosure.

In the embodiments of the present disclosure, the cell handover based on the layer 1 or layer 2 signaling is an intra-DU handover, or the cell handover based on the layer 1 or layer 2 signaling is an inter-DU handover.

It should be noted that one CU can be associated with one or more DUs, each DU is associated with one or more cells, the intra-DU handover indicates that the target cell of the handover and the source cell are managed by the same DU, the inter-DU handover indicates that the target cell of the handover and the source cell are managed by different DUs. That is, for the inter-DU handover, there are the source DU and a target DU, and for the intra-DU handover, the source DU is the target DU.

In some embodiments, the CU may determine, according to the first measurement report information acquired from a source DU, whether to perform the cell handover based on the layer 1 or layer 2 signaling, and in a case of determining to perform the cell handover based on the layer 1 or layer 2 signaling, determine the target cell based on the first measurement report information.

In some embodiments, the first network device may be a base station, such as a gNB.

Optionally, as Example 1, the first measurement report information includes but is not limited to at least one of:
all measurement results reported by the terminal device within a past time period T₁, a latest measurement result reported by the terminal device within the past time period T₁, or latest N₁ measurement results reported by the terminal device within the past time period T₁;
where T₁ is a positive number and N₁ is a positive integer.

Optionally, in Example 1, the source DU reports the first measurement report information to the CU once every time period T₁. That is, the source DU may periodically report the first measurement report information to the CU, where the period is the time period T₁.

In some embodiments, the time period T₁ is configured by the CU, or the time period T₁ is configured by the source DU.

In some embodiments, the N₁ is configured by the CU, or the N₁ is configured by the source DU.

Optionally, as Example 2, the first measurement report information includes but is not limited to at least one of:
all measurement results reported by the terminal device within a past time period T₂, a latest measurement result reported by the terminal device, or the latest N₂ measurement results reported by the terminal device;
where T₂ is a positive number and N₂ is a positive integer.

Optionally, in Example 2, the first measurement report information is transmitted from the source DU based on a first F1 interface message transmitted from the CU; where the first F1 interface message includes first indication information and/or second indication information, the first indication information is used for indicating the source DU to report the measurement result reported by the terminal device, and the second indication information is used for indicating the source DU to report a measurement result of a first measurement object.

In other words, the CU indicates, through the second indication information, to expect the source DU to report the measurement result of the first measurement object.

Optionally, a type of the first measurement object includes but is not limited to one of: a frequency information list, a frequency and PCI combination information list, or a PCI information list (in this case, the frequencies associated with these PCIs are the current serving cell frequencies of the terminal device).

Optionally, in Example 2, the first measurement report information includes measurement results of one or more cells corresponding to the first measurement object.

In some embodiments, the time period T₂ is configured by the CU, or the time period T₂ is configured by the source DU.

In some embodiments, the N₂ is configured by the CU, or the N₂ is configured by the source DU.

Optionally, as Example 3, the first measurement report information includes a measurement result currently reported by the terminal device. That is, each time the source DU receives a measurement result reported by the terminal device, the source DU transmits the measurement result to the CU through the first measurement report information.

In some embodiments, the measurement result included in the first measurement report information is a measurement result of at least one cell;
where the at least one cell is configured by the CU.

For example, the at least one cell is a cell being of interest to the CU. That is, the CU may configure the source DU to only report a measurement result of at least one cell being of interest at a time.

In some embodiments, the first measurement report information is carried in an F1 application protocol (F1AP) message. Of course, the first measurement report information may also be carried by other messages, which is not limited in the present disclosure.

In some embodiments, the CU transmits first handover indication information to the source DU, the first handover indication information is used for indicating the source DU to perform the cell handover based on layer 1 or layer 2 signaling, and the first handover indication information at least includes an identity of the target cell.

In some embodiments, the first handover indication information is carried in a terminal context modification request (UE CONTEXT MODIFICATION REQUEST) message, or the first handover indication information is carried in an FAP message.

In some embodiments, after the source DU receives the first handover indication information, the source DU generates second handover indication information, and transmits the second handover indication information to the terminal device, where the second handover indication information is used for indicating the terminal device to switch to the target cell. Optionally, the second handover indication information is carried in the layer 1 or layer 2 signaling. For example, the second handover indication information is carried in a media access control control element (MAC CE) or downlink control information (DCI).

In some embodiments, the CU receives feedback information corresponding to the first handover indication information transmitted from the source DU. For example, before the second handover indication information is transmitted, the source DU transmits feedback information corresponding to the first handover indication information to the CU.

In some embodiments, the feedback information corresponding to the first handover indication information is carried in a terminal context modification response (UE CONTEXT MODIFICATION RESPONSE) message, or the feedback information corresponding to the first handover indication information is carried in an FAP message.

In some embodiments, the measurement result is reported by the terminal device to the source DU through uplink control information (UCI) and/or MAC CE.

In some embodiments, the measurement result is a result obtained by the terminal device measuring a target object; where the target object is at least one of: a current serving cell, a candidate cell, a synchronization signal block (SSB) of a neighbor cell, or a channel state information-reference signal (CSI-RS).

In some embodiments, the measurement result is cell quality and/or beam quality of the target object;
where the cell quality or beam quality is characterized by one or more of following indicators:
reference signal received power (RSRP), reference signal received quality (RSRQ), or signal to interference plus noise ratio (SINR).

In some embodiments, for the inter-DU handover: before the CU transmits first handover indication information to a source DU, the CU needs to establish context information of the terminal device in the target DU. After the target DU receives an access request/first uplink message transmitted by the terminal device successfully, the target DU transmits a handover success feedback message to the CU. The handover success feedback message is used for informing the CU that the terminal device has successfully completed access to the target DU; the CU notifies the source DU to release the context information of the terminal device.

In some embodiments, for the intra-DU handover, the first handover indication information may be included in the terminal context modification request (UE CONTEXT MODIFICATION REQUEST) message. After the source DU feeds back the terminal context modification response (UE CONTEXT MODIFICATION RESPONSE) message to the CU, the source DU generates second handover indication information and transmits the second handover indication information to the terminal device.

Therefore, in the embodiments of the present disclosure, the CU implements the cell handover decision based on the layer 1 or layer 2 signaling, thereby realizing the cell handover based on the layer 1 or layer 2 signaling in a CU-DU separation architecture.

The CU side embodiments of the present disclosure have been described in detail above with reference to FIG. 6. The source DU side embodiments of the present disclosure will be described in detail below with reference to FIG. 7. It should be understood that the source DU side embodiments and the CU side embodiments correspond to each other, and similar descriptions can refer to the CU side embodiments.

FIG. 7 is a schematic flowchart of a wireless communication method 300 according to the embodiments of the present disclosure. The wireless communication method 300 is applied to a second network device, the second network device includes a source DU. As shown in FIG. 7, the wireless communication method 300 may include at least part of the following contents.

In S310, the source DU transmits first measurement report information to a CU; where the first measurement report information includes a measurement result reported by a terminal device, and the first measurement report information is used for the CU to determine whether to perform a cell handover based on a layer 1 or layer 2 signaling.

In the embodiments of the present disclosure, the CU implements a cell handover decision based on the layer 1 or layer 2 signaling, thereby realizing the cell handover based on the layer 1 or layer 2 signaling in a CU-DU separation architecture.

It should be understood that “the cell handover based on the layer 1 or layer 2 signaling” may also be referred to as “L1/L2 handover”, which is not limited in the present disclosure.

In the embodiments of the present disclosure, the cell handover based on the layer 1 or layer 2 signaling is an intra-DU handover, or the cell handover based on the layer 1 or layer 2 signaling is an inter-DU handover.

It should be noted that one CU can be associated with one or more DUs, each DU is associated with one or more cells, the intra-DU handover indicates that the target cell of the handover and the source cell are managed by the same DU, the inter-DU handover indicates that the target cell of the handover and the source cell are managed by different DUs. That is, for the inter-DU handover, there are the source DU and a target DU, and for the intra-DU handover, the source DU is the target DU.

In some embodiments, the CU may determine, according to the first measurement report information acquired from a source DU, whether to perform the cell handover based on the layer 1 or layer 2 signaling, and in a case of determining to perform the cell handover based on the layer 1 or layer 2 signaling, determine the target cell based on the first measurement report information.

In some embodiments, the second network device may be a base station, such as a gNB. Optionally, the second network device may be the same device as the first network device described above, or may be a different device, which is not limited in the present disclosure.

In some embodiments, the first measurement report information includes at least one of:
all measurement results reported by the terminal device within a past time period T₁, a latest measurement result reported by the terminal device within the past time period T₁, or latest N₁ measurement results reported by the terminal device within the past time period T₁;
where T₁ is a positive number and N₁ is a positive integer.

In some embodiments, the source DU reports the first measurement report information to the CU once every time period T₁. That is, the source DU may periodically report the first measurement report information to the CU, where the period is the time period T₁.

In some embodiments, the time period T₁ is configured by the CU, or the time period T₁ is configured by the source DU; and/or,
the N₁ is configured by the CU, or the N₁ is configured by the source DU.

In some embodiments, the first measurement report information includes at least one of:
all measurement results reported by the terminal device within a past time period T₂, a latest measurement result reported by the terminal device, or the latest N₂ measurement results reported by the terminal device;
where T₂ is a positive number and N₂ is a positive integer.

In some embodiments, the first measurement report information is transmitted from the source DU based on a first F1 interface message transmitted from the CU; where the first F1 interface message includes first indication information and/or second indication information, the first indication information is used for indicating the source DU to report the measurement result reported by the terminal device, and the second indication information is used for indicating the source DU to report a measurement result of a first measurement object.

In some embodiments, a type of the first measurement object includes one of: a frequency information list, a frequency and PCI combination information list, or a PCI information list.

In some embodiments, the first measurement report information further includes measurement results of one or more cells corresponding to the first measurement object.

In some embodiments, the time period T₂ is configured by the CU, or the time period T₂ is configured by the source DU; and/or,
the N₂ is configured by the CU, or the N₂ is configured by the source DU.

In some embodiments, the first measurement report information includes a measurement result currently reported by the terminal device. That is, each time the source DU receives a measurement result reported by the terminal device, the source DU transmits the measurement result to the CU through the first measurement report information.

In some embodiments, the measurement result included in the first measurement report information is a measurement result of at least one cell;
where the at least one cell is configured by the CU.

For example, the at least one cell is a cell being of interest to the CU. That is, the CU may configure the source DU to only report a measurement result of at least one cell being of interest once.

In some embodiments, the first measurement report information is carried in an F1AP message.

In some embodiments, the source DU receives first handover indication information transmitted from the CU, the first handover indication information is used for indicating the source DU to perform the cell handover based on the layer 1 or layer 2 signaling, and the first handover indication information at least includes an identity of a target cell determined by the CU.

In some embodiments, the first handover indication information is carried in a UE CONTEXT MODIFICATION REQUEST message, or the first handover indication information is carried in an F1AP message.

In some embodiments, the source DU transmits second handover indication information to the terminal device, where the second handover indication information is used for indicating the terminal device to switch to the target cell.

In some embodiments, after the source DU receives the first handover indication information, the source DU generates second handover indication information, and transmits the second handover indication information to the terminal device, where the second handover indication information is used for indicating the terminal device to switch to the target cell. Optionally, the second handover indication information is carried in the layer 1 or layer 2 signaling. For example, the second handover indication information is carried in a media access control control element (MAC CE) or downlink control information (DCI).

In some embodiments, before the source DU transmits the second handover indication information, the source DU transmits feedback information corresponding to the first handover indication information to the CU.

In some embodiments, the feedback information corresponding to the first handover indication information is carried in a UE CONTEXT MODIFICATION RESPONSE message, or the feedback information corresponding to the first handover indication information is carried in an F1AP message.

In some embodiments, the measurement result is reported by the terminal device to the source DU through UCI and/or MAC CE.

In some embodiments, the measurement result is a result obtained by the terminal device measuring a target object;
where the target object is at least one of: a current serving cell, a candidate cell, an SSB of a neighbor cell, or a CSI-RS.

In some embodiments, the measurement result is cell quality and/or beam quality of the target object;
where the cell quality or beam quality is characterized by one or more of following indicators:
RSRP, RSRQ, or SINR.

In some embodiments, for the inter-DU handover: before the CU transmits first handover indication information to a source DU, the CU needs to establish context information of the terminal device in a target DU. After the target DU receives an access request/first uplink message transmitted by the terminal device successfully, the target DU transmits a handover success feedback message to the CU. The handover success feedback message is used for informing the CU that the terminal device has successfully completed access to the target DU; the CU notifies the source DU to release the context information of the terminal device.

In some embodiments, for the intra-DU handover, the first handover indication information may be included in the terminal context modification request (UE CONTEXT MODIFICATION REQUEST) message. After the source DU feeds back the terminal context modification response (UE CONTEXT MODIFICATION RESPONSE) message to the CU, the source DU generates second handover indication information and transmits the second handover indication information to the terminal device.

Therefore, in the embodiments of the present disclosure, the CU implements the cell handover decision based on the layer 1 or layer 2 signaling, thereby realizing the cell handover based on the layer 1 or layer 2 signaling in a CU-DU separation architecture.

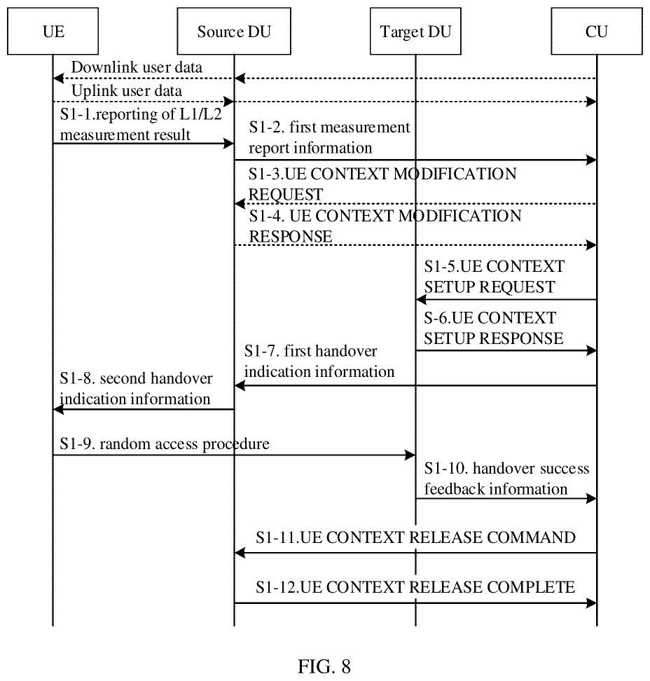

The technical solutions of the present disclosure will be described in detail below through Embodiment 1. In Embodiment 1, the CU determines whether to perform a cell handover based on a layer 1 or layer 2 signaling. As shown in FIG. 8, the process includes part or all of the following steps S1-1 to S1-12.

In S1-1, the UE transmits L1/L2 measurement results to the source DU. For example, the network transmits a message including at least a first measurement configuration to the UE. The UE measures the measurement target according to the first measurement configuration and reports the measurement result. Herein, the measurement target may be an SSB and/or CSI-RS of the current serving cell/candidate cell/neighbor cell; the measurement result may be cell quality and/or beam quality of the current serving cell/candidate cell/neighboring cell, and the cell quality/beam quality is characterized by one or more indicators such as RSRP, RSRQ, SINR. The measurement result is reported to the network through UCI and/or MAC CE.

In S1-2, the source DU transmits first measurement report information to the CU, where the first measurement report information includes the measurement result reported by the terminal device. The first measurement report information is described in the relevant description in the wireless communication method 200, which will not be repeated herein.

In S1-3, the CU transmits a UE context modification request to the source DU.

In S1-4, the source DU transmits a UE context modification response to the CU.

In S1-5, the CU transmits a UE context setup request to the target DU.

In S1-6, the target DU transmits a UE context setup response to the CU.

In S1-7, the CU transmits first handover indication information to the source DU, where the first handover indication information is used for indicating the source DU to perform a cell handover based on a layer 1 or layer 2 signaling, and the first handover indication information at least includes an identity of a target cell determined by the CU. For example, the CU determines to perform the cell handover based on the layer 1 or layer 2 signaling according to the first measurement report information, and determines the target cell.

In S1-8, the source DU transmits second handover indication information to the UE, where the second handover indication information is used for indicating the terminal device to switch to the target cell. Optionally, before the source DU transmits the second handover indication information, the source DU transmits feedback information corresponding to the first handover indication information to the CU.

In S1-9, the UE initiates a random access procedure to the target DU.

In S1-10, the target DU transmits a handover success feedback message to the CU.

In S1-11, the CU transmits a UE context release command (UE CONTEXT RELEASE COMMAND) to the source DU.

In S1-12, the source DU transmits a UE context release complete (UE CONTEXT RELEASE COMPLETE) to the CU.

Optionally, for the inter-DU handover: before the CU transmits a first handover indication information to a source DU, the CU needs to establish context information of the terminal device in the target DU. After the target DU receives an access request/first uplink message transmitted by the terminal device successfully, the target DU transmits a handover success feedback message to the CU. The handover success feedback message is used for informing the CU that the terminal device has successfully completed access to the target DU; the CU notifies the source DU to release the context information of the terminal device.

Optionally, for the intra-DU handover, the first handover indication information may be included in the terminal context modification request (UE CONTEXT MODIFICATION REQUEST) message. After the source DU feeds back the terminal context modification response (UE CONTEXT MODIFICATION RESPONSE) message to the CU, the source DU generates a second handover indication information and transmits the second handover indication information to the terminal device.

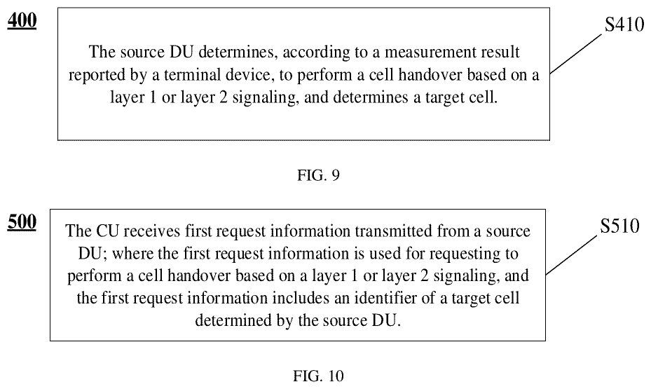

FIG. 9 is a schematic flowchart of a wireless communication method 400 according to the embodiments of the present disclosure. The wireless communication method 400 is applied to a third network device, the third network device includes a source DU. As shown in FIG. 9, the wireless communication method 400 may include at least part of the following contents.

In S410, the source DU determines, according to a measurement result reported by a terminal device, to perform a cell handover based on a layer 1 or layer 2 signaling, and determines a target cell.

In the embodiments of the present disclosure, the source DU implements a cell handover decision based on a layer 1 or layer 2 signaling, thereby realizing a cell handover based on the layer 1 or layer 2 signaling in a CU-DU separation architecture.

It should be understood that “the cell handover based on the layer 1 or layer 2 signaling” may also be referred to as “L1/L2 handover”, which is not limited in the present disclosure.

In the embodiments of the present disclosure, the cell handover based on the layer 1 or layer 2 signaling is an intra-DU handover, or the cell handover based on the layer 1 or layer 2 signaling is an inter-DU handover.

It should be noted that one CU can be associated with one or more DUs, each DU is associated with one or more cells, the intra-DU handover indicates that the target cell of the handover and the source cell are managed by the same DU, the inter-DU handover indicates that the target cell of the handover and the source cell are managed by different DUs. That is, for the inter-DU handover, there are the source DU and a target DU, and for the intra-DU handover, the source DU is the target DU.

In some embodiments, the source DU may determine, according to a measurement result reported by the terminal device, whether to perform the cell handover based on the layer 1 or layer 2 signaling, and in a case of determining to perform the cell handover based on the layer 1 or layer 2 signaling, determine the target cell based on the measurement result reported by the terminal device.

In some embodiments, the third network device may be a base station, such as a gNB.

In some embodiments, the source DU transmits first request information to the CU; where the first request information is used for requesting to perform the cell handover based on the layer 1 or layer 2 signaling, and the first request information includes an identity of the target cell.

In some embodiments, the first request information is carried in an F1AP message. Of course, the first request information may also be carried in other messages, which is not limited in the present disclosure.

In some embodiments, the source DU receives first feedback information transmitted from the CU;
where the first feedback information is determined based on the first request information, and the first feedback information is used for indicating whether the source DU performs the cell handover based on the layer 1 or layer 2 signaling.

In some embodiments, after the CU receives the first request information, the CU may indicate whether the source DU performs the cell handover based on the layer 1 or layer 2 signaling.

In some embodiments, the first feedback information is carried in an F1AP message. Of course, the first feedback information may also be carried in other messages, which is not limited in the present disclosure.

In some embodiments, in a case where the first feedback information indicates that the source DU performs the cell handover based on the layer 1 or layer 2 signaling, the source DU transmits a handover indication information to the terminal device, where the handover indication information is used for indicating the terminal device to switch to the target cell. Optionally, the handover indication information is carried in the layer 1 or layer 2 signaling. For example, the handover indication information is carried in MAC CE or DCI.

In some embodiments, the first request information further includes at least one of: second measurement report information, or latest configuration information of the terminal device;
where the second measurement report information includes a measurement result reported by the terminal device, and the second measurement report information is used for the CU to determine whether to indicate the source DU to perform the cell handover based on the layer 1 or layer 2 signaling.

Optionally, after the CU acquires the latest configuration information of the terminal device, the CU may determine whether to indicate the source DU to perform the cell handover based on the layer 1 or layer 2 signaling.

In some embodiments, a measurement result in the second measurement report information includes but is not limited to at least one of:
a cell level layer 1 measurement result of a serving cell, and/or, a beam level layer 1 measurement result of the serving cell;
a cell level layer 1 measurement result of at least one neighbor cell, and/or, a beam level layer 1 measurement result of at least one neighbor cell; or
a cell level layer 1 measurement result of the target cell, and/or a beam level layer 1 measurement result of the target cell.

In some embodiments, the second measurement report information includes but is not limited to at least one of:
all measurement results reported by the terminal device within a past time period T, a latest measurement result reported by the terminal device within the past time period T, latest N measurement results reported by the terminal device within the past time period T; a latest measurement result reported by the terminal device, latest N measurement results reported by the terminal device; or a measurement result currently reported by the terminal device;
where T is a positive number and N is a positive integer.

In some embodiments, the time period T is configured by the CU, or the time period T is configured by the source DU; and/or,
the N is configured by the CU, or the N is configured by the source DU.

In some embodiments, the second measurement report information is transmitted from the source DU based on a first F1 interface message transmitted from the CU;
where the first F1 interface message includes first indication information and second indication information, the first indication information is used for indicating the source DU to report the measurement result reported by the terminal device, and the second indication information is used for indicating the source DU to report a measurement result of a first measurement object.

In some embodiments, a type of the second measurement object includes one of: a frequency information list, a frequency and PCI combination information list, or a PCI information list (in this case, the frequencies associated with these PCIs are the current serving cell frequencies of the terminal device).

In some embodiments, the measurement result included in the second measurement report information is a measurement result of at least one cell;
where the at least one cell is configured by the CU.

For example, the at least one cell is a cell being of interest to the CU. That is, the CU may configure the source DU to only report a measurement result of at least one cell being of interest once.

In some embodiments, the source DU receives a terminal context modification request transmitted from the CU, where the terminal context modification request is used for requesting the latest terminal configuration information; and the source DU transmits a terminal context modification response to the CU, where the terminal context modification response includes the latest configuration information of the terminal device.

In some embodiments, the measurement result is reported by the terminal device to the source DU through UCI and/or MAC CE.

In some embodiments, the measurement result is a result obtained by the terminal device measuring a target object;
where the target object is at least one of: a current serving cell, a candidate cell, an SSB of a neighbor cell, or a CSI-RS.

In some embodiments, the measurement result is cell quality and/or beam quality of the target object;
where the cell quality or beam quality is characterized by one or more of following indicators: RSRP, RSRQ, or SINR.

In some embodiments, for the inter-DU handover: before the CU transmits first feedback information to the source DU, the CU needs to establish context information of the terminal device in the target DU. After the target DU successfully receives an access request/first uplink message transmitted by the terminal device, the target DU transmits a handover success feedback message to the CU. The handover success feedback message is used for informing the CU that the terminal device has successfully completed access to the target DU; the CU notifies the source DU to release the context information of the terminal device.

In some embodiments, for the intra-DU handover, the first feedback information may be included in the UE CONTEXT MODIFICATION REQUEST message. After the source DU feeds back the UE CONTEXT MODIFICATION RESPONSE message to the CU, the source DU generates handover indication information and transmits the second handover indication information to the terminal device.

Therefore, in the embodiments of the present disclosure, the source DU implements the cell handover decision based on the layer 1 or layer 2 signaling, thereby realizing the cell handover based on the layer 1 or layer 2 signaling in a CU-DU separation architecture.

The source DU side embodiments of the present disclosure have been described in detail above with reference to FIG. 9. The CU side embodiments of the present disclosure will be described in detail below with reference to FIG. 10. It should be understood that the CU side embodiments and the source DU side embodiments correspond to each other, and similar descriptions can refer to the source DU side embodiments.

FIG. 10 is a schematic flowchart of a wireless communication method 500 according to the embodiments of the present disclosure. The wireless communication method 500 is applied to a fourth network device, and the fourth network device includes a CU. As shown in FIG. 10, the wireless communication method 500 may include at least part of the following contents.

In S510, the CU receives first request information transmitted from a source DU; where the first request information is used for requesting to perform a cell handover based on a layer 1 or layer 2 signaling, and the first request information includes an identity of a target cell determined by the source DU.

In the embodiments of the present disclosure, the source DU implements a cell handover decision based on a layer 1 or layer 2 signaling, thereby realizing a cell handover based on the layer 1 or layer 2 signaling in a CU-DU separation architecture.

It should be understood that “the cell handover based on the layer 1 or layer 2 signaling” may also be referred to as “L1/L2 handover”, which is not limited in the present disclosure.

In the embodiments of the present disclosure, the cell handover based on the layer 1 or layer 2 signaling is an intra-DU handover, or the cell handover based on the layer 1 or layer 2 signaling is an inter-DU handover.

It should be noted that one CU can be associated with one or more DUs, each DU is associated with one or more cells, the intra-DU handover indicates that the target cell of the handover and the source cell are managed by the same DU, the inter-DU handover indicates that the target cell of the handover and the source cell are managed by different DUs. That is, for the inter-DU handover, there are the source DU and a target DU, and for the intra-DU handover, the source DU is the target DU.

In some embodiments, the source DU determines, according to a measurement result reported by the terminal device, whether to perform the cell handover based on the layer 1 or layer 2 signaling, and in a case of determining to perform the cell handover based on the layer 1 or layer 2 signaling, determines the target cell based on the measurement result reported by the terminal device.

In some embodiments, the fourth network device may be a base station, such as a gNB. Optionally, the fourth network device may be the same device as the third network device described above, or may be a different device, which is not limited in the present disclosure.

In some embodiments, the first request information is carried in an F1AP message. Of course, the first request information may also be carried in other messages, which is not limited in the present disclosure.

In some embodiments, the CU transmits first feedback information to the source DU;
where the first feedback information is determined based on the first request information, where the first feedback information is used for indicating whether the source DU performs the cell handover based on the layer 1 or layer 2 signaling.

In some embodiments, after the CU receives the first request information, the CU may indicate whether the source DU performs the cell handover based on the layer 1 or layer 2 signaling.

In some embodiments, the first feedback information is carried in an F1AP message. Of course, the first feedback information may also be carried in other messages, which is not limited in the present disclosure.

In some embodiments, in a case where the first feedback information indicates the source DU to perform the cell handover based on the layer 1 or layer 2 signaling, the source DU transmits a handover indication information to the terminal device, where the handover indication information is used for indicating the terminal device to switch to the target cell. Optionally, the handover indication information is carried in the layer 1 or layer 2 signaling. For example, the handover indication information is carried in MAC CE or DCI.

In some embodiments, the first request information further includes at least one of: second measurement report information, or latest configuration information of the terminal device;
where the second measurement report information includes a measurement result reported by the terminal device, and the second measurement report information is used for the CU to determine whether to indicate the source DU to perform the cell handover based on the layer 1 or layer 2 signaling.

Optionally, after the CU acquires the latest configuration information of the terminal device, the CU may determine whether to indicate the source DU to perform the cell handover based on the layer 1 or layer 2 signaling.

In some embodiments, a measurement result in the second measurement report information includes but is not limited to at least one of:
a cell level layer 1 measurement result of a serving cell, and/or, a beam level layer 1 measurement result of the serving cell;
a cell level layer 1 measurement result of at least one neighbor cell, and/or, a beam level layer 1 measurement result of at least one neighbor cell; or
a cell level layer 1 measurement result of the target cell, and/or a beam level layer 1 measurement result of the target cell.

In some embodiments, the second measurement report information includes at least one of:
all measurement results reported by the terminal device within a past time period T, a latest measurement result reported by the terminal device within the past time period T, latest N measurement results reported by the terminal device within the past time period T; a latest measurement result reported by the terminal device, latest N measurement results reported by the terminal device; or a measurement result currently reported by the terminal device;
where T is a positive number and N is a positive integer.

In some embodiments, the time period T is configured by the CU, or the time period T is configured by the source DU; and/or,
the N is configured by the CU, or the N is configured by the source DU.

In some embodiments, the second measurement report information is transmitted from the source DU based on a first F1 interface message transmitted from the CU;
where the first F1 interface message includes first indication information and second indication information, the first indication information is used for indicating the source DU to report the measurement result reported by the terminal device, and the second indication information is used for indicating the source DU to report a measurement result of a first measurement object.

In some embodiments, a type of the second measurement object includes one of: a frequency information list, a frequency and PCI combination information list, or a PCI information list (in this case, the frequencies associated with these PCIs are the current serving cell frequencies of the terminal device).

In some embodiments, the measurement result included in the second measurement report information is a measurement result of at least one cell;
where the at least one cell is configured by the CU.

For example, the at least one cell is a cell being of interest to the CU. That is, the CU may configure the source DU to only report measurement results of at least one cell being of interest once.

In some embodiments, the CU transmits a terminal context modification request to the source DU, where the terminal context modification request is used for requesting the latest terminal configuration information; and the CU receives a terminal context modification response transmitted from the source DU, where the terminal context modification response includes the latest configuration information of the terminal device.

In some embodiments, the measurement result is reported by the terminal device to the source DU through UCI and/or MAC CE.

In some embodiments, the measurement result is a result obtained by the terminal device measuring a target object;
where the target object is at least one of: a current serving cell, a candidate cell, an SSB of a neighbor cell, or a CSI-RS.

In some embodiments, the measurement result is cell quality and/or beam quality of the target object;
where the cell quality or beam quality is characterized by one or more of following indicators: RSRP, RSRQ, or SINR.

In some embodiments, for the inter-DU handover: before the CU transmits first feedback information to a source DU, the CU needs to establish context information of the terminal device in the target DU. After the target DU receives an access request/first uplink message transmitted by the terminal device successfully, the target DU transmits a handover success feedback message to the CU. The handover success feedback message is used for informing the CU that the terminal device has successfully completed access to the target DU; the CU notifies the source DU to release the context information of the terminal device.

In some embodiments, for the intra-DU handover, the first feedback information may be included in the UE CONTEXT MODIFICATION REQUEST message. After the source DU feeds back the UE CONTEXT MODIFICATION RESPONSE message to the CU, the source DU generates handover indication information and transmits the second handover indication information to the terminal device.

Therefore, in the embodiments of the present disclosure, the source DU implements the cell handover decision based on the layer 1 or layer 2 signaling, thereby realizing the cell handover based on the layer 1 or layer 2 signaling in a CU-DU separation architecture.

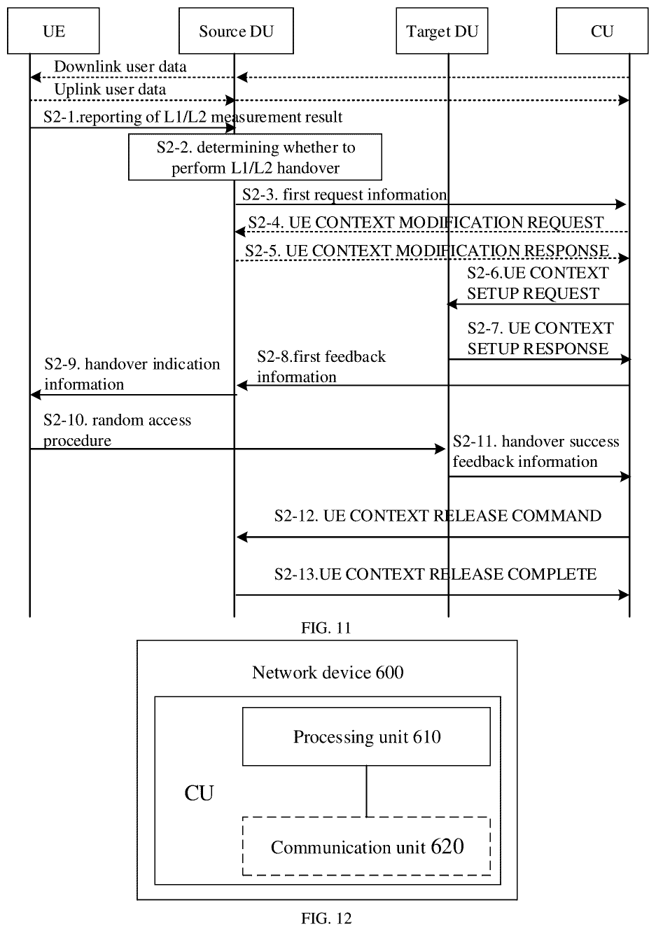

The technical solutions of the present disclosure will be described in detail below through Embodiment 2. In Embodiment 2, the source DU determines whether to perform a cell handover based on a layer 1 or layer 2 signaling. As shown in FIG. 11, the process includes part or all of the following steps S2-1 to S2-13.

In S2-1, the UE transmits a L1/L2 measurement result to the source DU. For example, the network transmits a message including at least a first measurement configuration to the UE. The UE measures the measurement target according to the first measurement configuration and reports the measurement result. Herein, the measurement target may be an SSB and/or CSI-RS of the current serving cell/candidate cell/neighbor cell; the measurement result may be cell quality and/or beam quality of the current serving cell/candidate cell/neighboring cell, and the cell quality/beam quality is characterized by one or more indicators such as RSRP, RSRQ, SINR. The measurement result is reported to the network through UCI and/or MAC CE.

In S2-2, the source DU determines, according to the measurement result reported by the UE, whether to perform a cell handover based on the layer 1 or layer 2 signaling and in a case of determining to perform the cell handover based on the layer 1 or layer 2 signaling, determines a target cell according to the measurement result reported by the UE.

In S2-3. the source DU transmits first request information to the CU; where the first request information is used for requesting to perform the cell handover based on the layer 1 or layer 2 signaling, and the first request information includes an identity of the target cell determined by the source DU.

In S2-4. the CU transmits a UE context modification request to the source DU.

In S2-5, the source DU transmits a UE context modification response to the CU.

In S2-6, the CU transmits a UE context setup request to the target DU.

In S2-7, the target DU transmits a UE context setup response to the CU.

In S2-8, the CU transmits first feedback information to the source DU, where the first feedback information is determined based on the first request information, and the first feedback information is used for indicating whether the source DU performs the cell handover based on the layer 1 or layer 2 signaling.

In S2-9, in a case where the first feedback information indicates the source DU to perform the cell handover based on the layer 1 or layer 2 signaling, the source DU transmits handover indication information to the UE, the handover indication information is used for indicating the terminal device to switch to the UE.

In S2-10, the UE initiates a random access procedure to the target DU.

In S2-11, the target DU transmits a handover success feedback message to the CU.

In S2-12, the CU transmits a UE context release command to the source DU.

In S2-13, the source DU transmits a UE context release complete to the CU.

Optionally, for the inter-DU handover: before the CU transmits first feedback information to the source DU, the CU needs to establish context information of the terminal device in the target DU. After the target DU receives an access request/first uplink message transmitted by the terminal device successfully, the target DU transmits a handover success feedback message to the CU. The handover success feedback message is used for informing the CU that the terminal device has successfully completed access to the target DU; the CU notifies the source DU to release the context information of the terminal device.

Optionally, for the intra-DU handover, the first feedback information may be included in the UE CONTEXT MODIFICATION REQUEST message. After the source DU feeds back the UE CONTEXT MODIFICATION RESPONSE message to the CU, the source DU generates handover indication information and transmits the handover indication information to the terminal device.

The method embodiments of the present disclosure have been described in detail above with reference to FIGS. 6 to 11. The apparatus embodiments of the present disclosure will be described in detail below with reference to FIGS. 12 to 18. It should be understood that the apparatus embodiments and the method embodiments correspond to each other, and similar descriptions can refer to the method embodiments.

FIG. 12 illustrates a schematic block diagram of a network device 600 according to the embodiments of the present disclosure. As shown in FIG. 12, the network device 600 is a first network device, and the first network device includes a centralized unit (CU). The CU in the network device 600 includes:
a processing unit 610, configured to determine, according to first measurement report information acquired from a source distributed unit (DU), to perform a cell handover based on a layer 1 or layer 2 signaling, and determine a target cell;
where the first measurement report information includes a measurement result reported by the terminal device.

In some embodiments, the first measurement report information includes at least one of:
all measurement results reported by the terminal device within a past time period T₁, a latest measurement result reported by the terminal device within the past time period T₁, or latest N₁ measurement results reported by the terminal device within the past time period T₁;
where T₁ is a positive number and N₁ is a positive integer.

In some embodiments, the source DU reports the first measurement report information to the CU once every time period T₁.

In some embodiments, the time period T₁ is configured by the CU, or the time period T₁ is configured by the source DU; and/or,
the N₁ is configured by the CU, or the N₁ is configured by the source DU.

In some embodiments, the first measurement report information includes at least one of:
all measurement results reported by the terminal device within a past time period T₂, a latest measurement result reported by the terminal device, or latest N₂ measurement results reported by the terminal device;
where T₂ is a positive number and N₂ is a positive integer.

In some embodiments, the first measurement report information is transmitted from the source DU based on a first F1 interface message transmitted from the CU;
where the first F1 interface message includes first indication information and/or second indication information, the first indication information is used for indicating the source DU to report the measurement result reported by the terminal device, and the second indication information is used for indicating the source DU to report a measurement result of a first measurement object.

In some embodiments, a type of the first measurement object includes one of: a frequency information list, a frequency and physical cell identity (PCI) combination information list, or a PCI information list.

In some embodiments, the first measurement report information further includes a measurement result of one or more cells corresponding to the first measurement object.

In some embodiments, the time period T₂ is configured by the CU, or the time period T₂ is configured by the source DU; and/or,
the N₂ is configured by the CU, or the N₂ is configured by the source DU.

In some embodiments, the first measurement report information includes a measurement result currently reported by the terminal device.

In some embodiments, the measurement result included in the first measurement report information is a measurement result of at least one cell;
where the at least one cell is configured by the CU.

In some embodiments, the first measurement report information is carried in an F1 application protocol (F1AP) message.

In some embodiments, the cell handover based on the layer 1 or layer 2 signaling is an intra-DU handover, or the cell handover based on the layer 1 or layer 2 signaling is an inter-DU handover.

In some embodiments, the CU in the network device 600 further includes:
a communication unit 620, configured to transmit first handover indication information to the source DU, where the first handover indication information is used for indicating the source DU to perform the cell handover based on the layer 1 or layer 2 signaling, and the first handover indication information at least includes an identity of the target cell.

In some embodiments, the first handover indication information is carried in a UE CONTEXT MODIFICATION REQUEST message, or the first handover indication information is carried in an F1AP message.

In some embodiments, the communication unit 620 is further configured to receive feedback information corresponding to the first handover indication information transmitted from the source DU.

In some embodiments, the feedback information corresponding to the first handover indication information is carried in a UE CONTEXT MODIFICATION RESPONSE message, or the feedback information corresponding to the first handover indication information is carried in an F1AP message.

In some embodiments, the measurement result is reported by the terminal device to the source DU through uplink control information (UCI) and/or media access control control element (MAC CE).

In some embodiments, the measurement result is a result obtained by the terminal device measuring a target object;
where the target object is at least one of: a current serving cell, a candidate cell, a synchronization signal block (SSB) of a neighbor cell, or a channel state information-reference signal (CSI-RS).

In some embodiments, the measurement result is cell quality and/or beam quality of the target object;
where the cell quality or beam quality is characterized by one or more of following indicators:
reference signal received power (RSRP), reference signal received quality (RSRQ), or signal to interference plus noise ratio (SINR).

In some embodiments, the communication unit mentioned above may be a communication interface or a transceiver, or an input/output interface of a communication chip or a system on chip. The processing unit mentioned above may be one or more processors.

It should be understood that the network device 600 according to the embodiments of the present disclosure may correspond to the first network device in the method embodiments of the present disclosure, and the above-mentioned and other operations and/or functions of each unit in the network device 600 are respectively for implementing the corresponding processes of the first network device in the method 200 shown in FIG. 6, which will not be repeated herein for brevity.

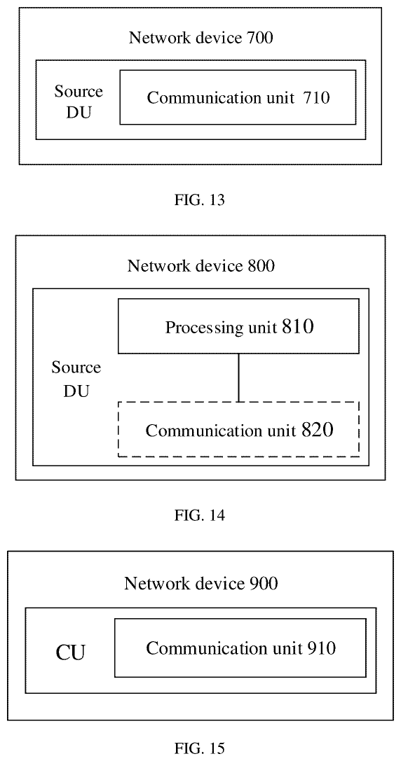

FIG. 13 illustrates a schematic block diagram of a network device 700 according to the embodiments of the present disclosure. As shown in FIG. 13, the network device 700 is a second network device, and the second network device includes a source distributed unit (DU). The source DU in the network device 600 includes:
a communication unit 710, configured to transmit first measurement report information to a centralized unit (CU);
where the first measurement report information includes a measurement result reported by a terminal device, and the first measurement report information is used for the CU to determine whether to perform a cell handover based on a layer 1 or layer 2 signaling.

In some embodiments, the first measurement report information includes at least one of:
all measurement results reported by the terminal device within a past time period T₁, a latest measurement result reported by the terminal device within the past time period T₁, or latest N₁ measurement results reported by the terminal device within the past time period T₁;
where T₁ is a positive number and N₁ is a positive integer.

In some embodiments, the source DU reports the first measurement report information to the CU once every time period T₁.

In some embodiments, the time period T₁ is configured by the CU, or the time period T₁ is configured by the source DU; and/or,
the N₁ is configured by the CU, or the N₁ is configured by the source DU.

In some embodiments, the first measurement report information includes at least one of:
all measurement results reported by the terminal device within a past time period T₂, a latest measurement result reported by the terminal device, or latest N₂ measurement results reported by the terminal device;
where T₂ is a positive number and N₂ is a positive integer.

In some embodiments, the first measurement report information is transmitted from the source DU based on a first F1 interface message transmitted from the CU;
where the first F1 interface message includes first indication information and/or second indication information, the first indication information is used for indicating the source DU to report the measurement result reported by the terminal device, and the second indication information is used for indicating the source DU to report a measurement result of a first measurement object.

In some embodiments, a type of the first measurement object includes one of: a frequency information list, a frequency and physical cell identity (PCI) combination information list, or a PCI information list.

In some embodiments, the first measurement report information further includes a measurement result of one or more cells corresponding to the first measurement object.

In some embodiments, the time period T₂ is configured by the CU, or the time period T₂ is configured by the source DU; and/or,
the N₂ is configured by the CU, or the N₂ is configured by the source DU.

In some embodiments, the first measurement report information includes a measurement result currently reported by the terminal device.

In some embodiments, the measurement result included in the first measurement report information is a measurement result of at least one cell;
where the at least one cell is configured by the CU.

In some embodiments, the first measurement report information is carried in an F1 application protocol (F1AP) message.

In some embodiments, the cell handover based on the layer 1 or layer 2 signaling is an intra-DU handover, or the cell handover based on the layer 1 or layer 2 signaling is an inter-DU handover.

In some embodiments, the communication unit 710 is further configured to receive first handover indication information transmitted from the CU, where the first handover indication information is used for indicating the source DU to perform the cell handover based on the layer 1 or layer 2 signaling, and the first handover indication information includes at least an identity of a target cell determined by the CU.

In some embodiments, the first handover indication information is carried in a UE CONTEXT MODIFICATION REQUEST message, or the first handover indication information is carried in an F1AP message.

In some embodiments, the communication unit 710 is further configured to transmit second handover indication information to the terminal device, where the second handover indication information is used for indicating the terminal device to switch to the target cell.

In some embodiments, the second handover indication information is carried in the layer 1 or layer 2 signaling.

In some embodiments, the layer 1 or layer 2 signaling is a media access control control element (MAC CE) or downlink control information (DCI).

In some embodiments, before the second handover indication information is transmitted, the communication unit 710 is further configured to transmit feedback information corresponding to the first handover indication information to the CU.

In some embodiments, the feedback information corresponding to the first handover indication information is carried in a UE CONTEXT MODIFICATION RESPONSE message, or the feedback information corresponding to the first handover indication information is carried in an F1AP message.

In some embodiments, the measurement result is reported by the terminal device to the source DU through uplink control information (UCI) and/or media access control control element (MAC CE).

In some embodiments, the measurement result is a result obtained by the terminal device measuring a target object;
where the target object is at least one of: a current serving cell, a candidate cell, a synchronization signal block (SSB) of a neighbor cell, or a channel state information-reference signal (CSI-RS).

In some embodiments, the measurement result is cell quality and/or beam quality of the target object;
where the cell quality or beam quality is characterized by one or more of following indicators:
reference signal received power (RSRP), reference signal received quality (RSRQ), or signal to interference plus noise ratio (SINR).

In some embodiments, the communication unit mentioned above may be a communication interface or a transceiver, or an input/output interface of a communication chip or a system on chip. The processing unit mentioned above may be one or more processors.

It should be understood that the network device 700 according to the embodiments of the present disclosure may correspond to the second network device in the method embodiments of the present disclosure, and the above-mentioned and other operations and/or functions of each unit in the network device 700 are respectively for implementing the corresponding processes of the second network device in the method 300 shown in FIG. 7, which will not be repeated herein for brevity.

FIG. 14 illustrates a schematic block diagram of a network device 800 according to the embodiments of the present disclosure. As shown in FIG. 14, the network device 800 is a third network device, and the third network device includes a source distributed unit (DU). The source DU in the network device 800 includes:
a processing unit 810, configured to determine, according to a measurement result reported by a terminal device, to perform a cell handover based on a layer 1 or layer 2 signaling, and determine a target cell.

In some embodiments, the source DU in the network device 800 further includes:
a communication unit 820, configured to transmit first request information to a centralized unit (CU);
where the first request information is used for requesting to perform the cell handover based on the layer 1 or layer 2 signaling, and the first request information includes an identity of the target cell.

In some embodiments, the first request information is carried in an F1 application protocol (F1AP) message.

In some embodiments, the communication unit 820 is further configured to receive first feedback information transmitted from the CU;
where the first feedback information is determined based on the first request information, and the first feedback information is used for indicating whether the source DU performs the cell handover based on the layer 1 or layer 2 signaling.

In some embodiments, the first feedback information is carried in the FLAP message.

In some embodiments, in a case where the first feedback information indicates the source DU to perform the cell handover based on the layer 1 or layer 2 signaling, the communication unit 820 is further configured to transmit a handover indication information to the terminal device, where the handover indication information is used for indicating the terminal device to switch to the target cell.

In some embodiments, the handover indication information is carried in the layer 1 or layer 2 signaling.

In some embodiments, the layer 1 or layer 2 signaling is a media access control control element (MAC CE) or downlink control information (DCI).

In some embodiments, the first request information further includes at least one of: second measurement report information, or latest configuration information of the terminal device;
where the second measurement report information includes a measurement result reported by the terminal device, and the second measurement report information is used for the CU to determine whether to indicate the source DU to perform the cell handover based on the layer 1 or layer 2 signaling.

In some embodiments, the measurement result in the second measurement report information includes at least one of:
a cell level layer 1 measurement result of a serving cell, and/or, a beam level layer 1 measurement result of the serving cell;
a cell level layer 1 measurement result of at least one neighbor cell, and/or, a beam level layer 1 measurement result of at least one neighbor cell; or
a cell level layer 1 measurement result of the target cell, and/or a beam level layer 1 measurement result of the target cell.

In some embodiments, the second measurement report information includes at least one of:
all measurement results reported by the terminal device within a past time period T, a latest measurement result reported by the terminal device within the past time period T, latest N measurement results reported by the terminal device within the past time period T; a latest measurement result reported by the terminal device, latest N measurement results reported by the terminal device; or a measurement result currently reported by the terminal device;
where T is a positive number and N is a positive integer.

In some embodiments, the time period T is configured by the CU, or the time period T is configured by the source DU; and/or,
the N is configured by the CU, or the N is configured by the source DU.

In some embodiments, the second measurement report information is transmitted from the source DU based on a first F1 interface message transmitted from the CU;
where the first F1 interface message includes first indication information and second indication information, the first indication information is used for indicating the source DU to report the measurement result reported by the terminal device, and the second indication information is used for indicating the source DU to report a measurement result of a first measurement object.

In some embodiments, a type of the second measurement object includes one of: a frequency information list, a frequency and physical cell identity (PCI) combination information list, or a PCI information list.

In some embodiments, the measurement result included in the second measurement report information is a measurement result of at least one cell;
where the at least one cell is configured by the CU.

In some embodiments, the communication unit 820 is further configured to receive a terminal context modification request transmitted from the CU, where the terminal context modification request is used for requesting the latest terminal configuration information;
the communication unit 820 is further configured to transmit a terminal context modification response to the CU, where the terminal context modification response includes the latest configuration information of the terminal device.

In some embodiments, the cell handover based on the layer 1 or layer 2 signaling is an intra-DU handover, or the cell handover based on the layer 1 or layer 2 signaling is an inter-DU handover.

In some embodiments, the measurement result is reported by the terminal device to the source DU through uplink control information (UCI) and/or media access control control element (MAC CE).

In some embodiments, the measurement result is a result obtained by the terminal device measuring a target object;
where the target object is at least one of: a current serving cell, a candidate cell, a synchronization signal block (SSB) of a neighbor cell, or a channel state information-reference signal (CSI-RS).

In some embodiments, the measurement result is cell quality and/or beam quality of the target object;
where the cell quality or beam quality is characterized by one or more of following indicators:
reference signal received power (RSRP), reference signal received quality (RSRQ), or signal to interference plus noise ratio (SINR).

In some embodiments, the communication unit mentioned above may be a communication interface or a transceiver, or an input/output interface of a communication chip or a system on chip. The processing unit mentioned above may be one or more processors.

It should be understood that the network device 800 according to the embodiments of the present disclosure may correspond to the third network device in the method embodiments of the present disclosure, and the above-mentioned and other operations and/or functions of each unit in the network device 800 are respectively for implementing the corresponding processes of the third network device in the method 400 shown in FIG. 9, which will not be repeated herein for brevity.

FIG. 15 illustrates a schematic block diagram of a network device 900 according to the embodiments of the present disclosure. As shown in FIG. 15, the network device 900 is a fourth network device, and the fourth network device includes a centralized unit (CU). The CU in the network device 900 includes:
a communication unit 910, configured to receive first request information transmitted from a source distributed unit (DU);
where the first request information is used for requesting to perform a cell handover based on the a layer 1 or layer 2 signaling, and the first request information includes an identity of a target cell determined by the source DU.

In some embodiments, the first request information is carried in an F1 application protocol (F1AP) message.

In some embodiments, the communication unit 910 is further configured to transmit first feedback information to the source DU;
where the first feedback information is determined based on the first request information, and the first feedback information is used for indicating whether the source DU performs the cell handover based on the layer 1 or layer 2 signaling.

In some embodiments, the first feedback information is carried in the F1AP message.

In some embodiments, the first request information further includes at least one of: second measurement report information, or latest configuration information of the terminal device;
where the second measurement report information includes a measurement result reported by the terminal device, and the second measurement report information is used for the CU to determine whether to indicate the source DU to perform the cell handover based on the layer 1 or layer 2 signaling.

In some embodiments, the measurement result in the second measurement report information includes at least one of:
a cell level layer 1 measurement result of a serving cell, and/or, a beam level layer 1 measurement result of the serving cell;
a cell level layer 1 measurement result of at least one neighbor cell, and/or, a beam level layer 1 measurement result of at least one neighbor cell; or
a cell level layer 1 measurement result of the target cell, and/or a beam level layer 1 measurement result of the target cell.

In some embodiments, the second measurement report information includes at least one of:
all measurement results reported by the terminal device within a past time period T, a latest measurement result reported by the terminal device within the past time period T, latest N measurement results reported by the terminal device within the past time period T; a latest measurement result reported by the terminal device, latest N measurement results reported by the terminal device; or a measurement result currently reported by the terminal device;
where T is a positive number and N is a positive integer.

In some embodiments, the time period T is configured by the CU, or the time period T is configured by the source DU; and/or,
the N is configured by the CU, or the N is configured by the source DU.

In some embodiments, the second measurement report information is transmitted from the source DU based on a first F1 interface message transmitted from the CU;
where the first F1 interface message includes first indication information and second indication information, the first indication information is used for indicating the source DU to report the measurement result reported by the terminal device, and the second indication information is used for indicating the source DU to report a measurement result of a first measurement object.

In some embodiments, a type of the second measurement object includes one of: a frequency information list, a frequency and physical cell identity (PCI) combination information list, or a PCI information list.

In some embodiments, the measurement result included in the second measurement report information is a measurement result of at least one cell;
where the at least one cell is configured by the CU.

In some embodiments, the communication unit 910 is further configured to transmit a terminal context modification request to the source DU, where the terminal context modification request is used for requesting the latest terminal configuration information;
the communication unit 910 is further configured to receive a terminal context modification response transmitted from the source DU, and the terminal context modification response includes the latest configuration information of the terminal device.

In some embodiments, the cell handover based on the layer 1 or layer 2 signaling is an intra-DU handover, or the cell handover based on the layer 1 or layer 2 signaling is an inter-DU handover.

In some embodiments, the measurement result is reported by the terminal device to the source DU through uplink control information (UCI) and/or media access control control element (MAC CE).

In some embodiments, the measurement result is a result obtained by the terminal device measuring a target object;
where the target object is at least one of: a current serving cell, a candidate cell, a synchronization signal block (SSB) of a neighbor cell, or a channel state information-reference signal (CSI-RS).

In some embodiments, the measurement result is cell quality and/or beam quality of the target object;
where the cell quality or beam quality is characterized by one or more of following indicators:
reference signal received power (RSRP), reference signal received quality (RSRQ), or signal to interference plus noise ratio (SINR).

In some embodiments, the communication unit mentioned above may be a communication interface or a transceiver, or an input/output interface of a communication chip or a system on chip. The processing unit mentioned above may be one or more processors.

It should be understood that the network device 900 according to the embodiments of the present disclosure may correspond to the fourth network device in the method embodiments of the present disclosure, and the above-mentioned and other operations and/or functions of each unit in the network device 900 are respectively for implementing the corresponding processes of the fourth network device in the method 500 shown in FIG. 10, which will not be repeated herein for brevity.

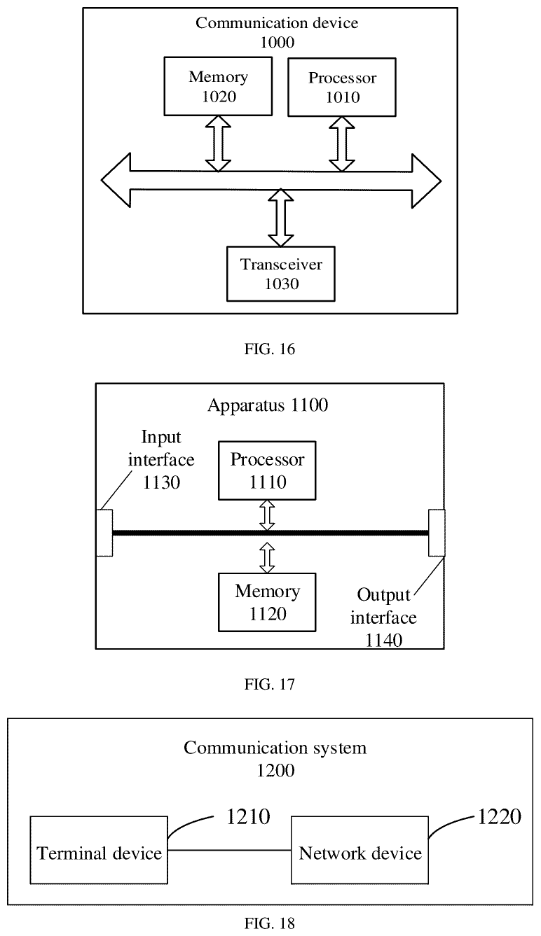

FIG. 16 is a schematic structural diagram of a communication device 1000 provided in the embodiments of the present disclosure. The communication device 1000 shown in FIG. 16 includes a processor 1010, which may call a computer program from a memory and run the computer program, so as to implement the methods in the embodiments of the present disclosure.

In some embodiments, as shown in FIG. 16, the communication device 1000 further includes a memory 1020. The processor 1010 may call and run a computer program from the memory 1020 to implement the method in the embodiments of the present disclosure.

The memory 1020 may be a separate device independent from the processor 1010, or may be integrated into the processor 1010.

In some embodiments, as shown in FIG. 16, the communication device 1000 may further include a transceiver 1030, and the processor 1010 may control the transceiver 1030 to communicate with other devices, and for example, to transmit information or data to other devices, or receive information or data transmitted by other devices.

The transceiver 1030 may include a transmitter and a receiver. The transceiver 1030 may further include antenna(s), and the number of antenna(s) may be one or more.

In some embodiments, the communication device 1000 may be the network device in the embodiments of the present disclosure, and the communication device 1000 may implement the corresponding procedure implemented by the network device (such as the first network device, the second network device, the third network device, and the fourth network device) in the various methods of the embodiments of the present disclosure, which will not be repeated herein for brevity.

FIG. 17 is a schematic structural diagram of an apparatus of the embodiments of the present disclosure. The apparatus 1100 shown in FIG. 17 includes a processor 1110, and the processor 1110 may call a computer program from a memory and run the computer program, so as to implement the method in the embodiments of the present disclosure.

In some embodiments, as shown in FIG. 17, the apparatus 1100 may further include a memory 1120. The processor 1110 may call and run a computer program from the memory 1120 to implement the method in the embodiments of the present disclosure.

The memory 1120 may be a separate device independent from the processor 1110, or may be integrated into the processor 1110.

In some embodiments, the apparatus 1100 may further include an input interface 1130. The processor 1110 may control the input interface 1130 to communicate with other devices or chips, and for example, the input interface 1130 may acquire information or data sent by other devices or chips.

In some embodiments, the apparatus 1100 may further include an output interface 1140. The processor 1110 may control the output interface 1140 to communicate with other devices or chips, and for example, the output interface 1140 may output information or data to other devices or chips.

In some embodiments, the apparatus may be applied to the network device in the embodiments of the present disclosure, and the apparatus may implement the corresponding procedure implemented by the network device (such as the first network device, the second network device, the third network device, and the fourth network device) in the various methods of the embodiments of the present disclosure, which will not be repeated herein for brevity.

In some embodiments, the apparatus mentioned in the embodiments of the present disclosure may also be a chip, such as a system on chip, a system chip, a chip system or a system-on-chip chip.

FIG. 18 is a schematic block diagram of a communication system 1200 provided in the embodiments of the present disclosure. As shown in FIG. 18, the communication system 1200 includes a terminal device 1210 and a network device 1220.

The terminal device 1210 may be used to implement the corresponding functions implemented by the terminal device in the above-mentioned methods, and the network device 1220 may be used to implement the corresponding functions implemented by the network device (such as the first network device, the second network device, the third network device, and the fourth network device) in the above-mentioned methods, which will not be repeated herein for brevity.

It should be understood that the processor in the embodiments of the present disclosure may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that, the memory in the embodiments of the present disclosure may be a volatile memory or a non-volatile memory, or may include both volatile and non-volatile memories. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which is used as an external cache. Through illustrative, rather than limiting, illustration, many forms of RAMs are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM) and a direct rambus random access memory (DR RAM). It should be noted that the memory of the system and the method described herein is intended to include, but not limited to, these and any other suitable types of memories.

It should be understood that the above memory is exemplary but not limiting illustration, e.g., the memory in embodiments of the present disclosure may also be a static random access memory (SRAM), a dynamic random access memory (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM). That is, the memory in the embodiments of the present disclosure is intended to include, but not limited to, these and any other suitable types of memories.

The embodiments of the present disclosure further provide a non-transitory computer readable storage medium for storing a computer program.

In some embodiments, the non-transitory computer readable storage medium may be applied to the network device in the embodiments of the present disclosure, and the computer program enables a computer to perform the corresponding procedure implemented by the network device (such as the first network device, the second network device, the third network device, and the fourth network device) in the various methods of the embodiments of the present disclosure, which will not be repeated herein for brevity.

The embodiments of the present disclosure further provide a computer program product including computer program instructions.

In some embodiments, the computer program product may be applied to the network device in the embodiments of the present disclosure, and the computer program instructions enable a computer to perform the corresponding procedure implemented by the network device (such as the first network device, the second network device, the third network device, and the fourth network device) in the various methods of the embodiments of the present disclosure, which will not be repeated herein for brevity.

The embodiments of the present disclosure further provide a computer program.

In some embodiments, the computer program may be applied to network device in the embodiments of the present disclosure, the computer program, upon being executed on a computer, enables the computer to perform the corresponding procedure implemented by the network device (such as the first network device, the second network device, the third network device, and the fourth network device) in various methods of the embodiments of the present disclosure, which will not be repeated herein for brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present disclosure.

It may be clearly understood by those skilled in the art that, for convenience and brevity of the description, the working procedures of the system, the apparatus and the unit described above may refer to the corresponding procedures in the above method embodiments, which will not be repeated herein.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the solutions of the embodiments.

In addition, the various functional units in the various embodiments of the present disclosure may be integrated into one processing unit, or the various units may exist physically separately, or two or more units may be integrated into one unit.

If the described functions are implemented in the form of a software functional unit and sold or used as an independent product, they may be stored in a non-transitory computer readable storage medium. Based on this understanding, the technical solution of the present disclosure essentially, or a part of the technical solution that contributes to the prior art, or a part of the technical solution, may be embodied in the form of a software product, and the computer software product is stored in a non-transitory storage medium, and includes a plurality of instructions for enabling a computer device (which may be a personal computer, a server, or a network device, etc.) to perform all or some of steps of the methods described in the various embodiments of the present disclosure. And, the non-transitory storage medium mentioned above includes a USB flash drive (U disk), a mobile hard disk, a read-only memory (ROM), a random access memory (RAM), a diskette, or an optical disk, and various mediums that may store program codes.

The above content is only implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A wireless communication method, wherein the method is applied to a third network device, the third network device comprises a source distributed unit (DU), the method comprises:
determining, by the source DU according to a measurement result reported by a terminal device, to perform a cell handover based on a layer 1 or layer 2 signaling, and determining a target cell.

2. The method according to claim 1, wherein the method further comprises:
transmitting, by the source DU, first request information to a centralized unit (CU);
wherein the first request information is used for requesting to perform the cell handover based on the layer 1 or layer 2 signaling, and the first request information comprises an identity of the target cell.

3. The method according to claim 2, wherein the first request information is carried in an F1 application protocol (F1AP) message.

4. The method according to claim 1, wherein the cell handover based on the layer 1 or layer 2 signaling is an intra-DU handover, or the cell handover based on the layer 1 or layer 2 signaling is an inter-DU handover.

5. The method according to claim 1, wherein the measurement result is reported by the terminal device to the source DU through uplink control information (UCI) and/or a media access control control element (MAC CE).

6. The method according to claim 1, wherein
the measurement result is a result obtained by the terminal device measuring a target object;
wherein the target object is at least one of: a current serving cell, a candidate cell, a synchronization signal block (SSB) of a neighbor cell, or a channel state information-reference signal (CSI-RS).

7. The method according to claim 6, wherein
the measurement result is cell quality and/or beam quality of the target object;
wherein the cell quality or beam quality is characterized by one or more of following indicators:
reference signal received power (RSRP), reference signal received quality (RSRQ), or signal to interference plus noise ratio (SINR).

8. A wireless communication method, wherein the method is applied to a fourth network device, the fourth network device comprises a centralized unit (CU), the method comprises:
receiving, by the CU, first request information transmitted from a source distributed unit (DU);
wherein the first request information is used for requesting to perform a cell handover based on a layer 1 or layer 2 signaling, and the first request information comprises an identity of a target cell determined by the source DU.

9. The method according to claim 8, wherein the first request information is carried in an F1 application protocol (F1AP) message.

10. The method according to claim 8, wherein the first request information further comprises at least one of: second measurement report information, or latest configuration information of the terminal device;
wherein the second measurement report information comprises a measurement result reported by the terminal device, and the second measurement report information is used for the CU to determine whether to indicate the source DU to perform the cell handover based on the layer 1 or layer 2 signaling.

11. The method according to claim 8, wherein the cell handover based on the layer 1 or layer 2 signaling is an intra-DU handover, or the cell handover based on the layer 1 or layer 2 signaling is an inter-DU handover.

12. The method according to claim 10, wherein the measurement result is reported by the terminal device to the source DU through uplink control information (UCI) and/or a media access control control element (MAC CE).

13. The method according to claim 10, wherein
the measurement result is a result obtained by the terminal device measuring a target object;
wherein the target object is at least one of: a current serving cell, a candidate cell, a synchronization signal block (SSB) of a neighbor cell, or a channel state information-reference signal (CSI-RS); wherein
the measurement result is cell quality and/or beam quality of the target object;
wherein the cell quality or beam quality is characterized by one or more of following indicators:
reference signal received power (RSRP), reference signal received quality (RSRQ), or signal to interference plus noise ratio (SINR).

14. A network device, comprising a processor and a memory, wherein the memory is configured to store a computer program, and the processor is configured to call and run the computer program stored in the memory, so as to enable the network device to perform:
determining, according to a measurement result reported by a terminal device, to perform a cell handover based on a layer 1 or layer 2 signaling, and determining a target cell; wherein the network device comprises a source distributed unit (DU).

15. The network device according to claim 14, wherein the network device further performs:
transmitting first request information to a centralized unit (CU);
wherein the first request information is used for requesting to perform the cell handover based on the layer 1 or layer 2 signaling, and the first request information comprises an identity of the target cell.

16. The network device according to claim 15, wherein the first request information is carried in an F1 application protocol (F1AP) message.

17. The network device according to claim 14, wherein the cell handover based on the layer 1 or layer 2 signaling is an intra-DU handover, or the cell handover based on the layer 1 or layer 2 signaling is an inter-DU handover.

18. The network device according to claim 14, wherein the measurement result is reported by the terminal device to the source DU through uplink control information (UCI) and/or a media access control control element (MAC CE).

19. The network device according to claim 14, wherein
the measurement result is a result obtained by the terminal device measuring a target object;
wherein the target object is at least one of: a current serving cell, a candidate cell, a synchronization signal block (SSB) of a neighbor cell, or a channel state information-reference signal (CSI-RS).

20. The network device according to claim 19, wherein
the measurement result is cell quality and/or beam quality of the target object;
wherein the cell quality or beam quality is characterized by one or more of following indicators:
reference signal received power (RSRP), reference signal received quality (RSRQ), or signal to interference plus noise ratio (SINR).
